(19) United States
(12) Patent Application Publication
(10) Pub. No.: US 2026/0008876 A1
(43) Pub. Date: Jan. 8, 2026

(54) ADDITIVE FOR A CATALYST

(71) Applicant: Dow Global Technologies LLC, Midland, MI (US)

(72) Inventors: Rhett A. Baillie, Missouri City, TX (US); Angela I. Padilla-Acevedo, Bartlesville, OK (US); Bethany M. Neilson, Manvel, TX (US); John F. Szul, Hurricane, WV (US)

(21) Appl. No.: 19/102,472

(22) PCT Filed: Oct. 28, 2024
(86) PCT No.: PCT/US2024/053201

§ 371 Date: Feb. 10, 2025

Related U.S. Application Data
(60) Provisional application No. 63/609,188, filed on Dec. 12, 2023.

(51) Int. Cl. C08F 210/16

(52) U.S. Cl. CPC C08F 210/16; C08F 2410/04

(57) ABSTRACT

A method of making a productivity enhanced bimodal catalyst, the method includes combining a non-metallocene precatalyst, a metallocene precatalyst, an effective amount of an activator, and an effective amount of an activity-enhancing compound to activate the non-metallocene precatalyst and the metallocene precatalyst into the productivity enhanced bimodal catalyst.

### FIELD OF DISCLOSURE

Embodiments of the present disclosure are directed towards a catalyst, more specifically, embodiments are directed towards an additive for a catalyst to produce a bimodal polymer.

### BACKGROUND

Polymers may be utilized for a number of products including films and pipes, among other things. Polymers can be formed by reacting one or more types of monomers in a polymerization reaction. There was continued focus in the industry on developing new and improved materials and/or processes that may be utilized to form polymers for existing and new products.

Among these polymers, bimodal high-density polyethylene (HDPE) is of great interest. Bimodal HDPE refers to a type of HDPE polymer that had both a high molecular weight component and a low molecular weight component, the “bimodal” molecular weight distribution. In a bimodal HDPE, two different sets of molecular weights are present, typically achieved through a two-step polymerization process or through a combination of different polymerization conditions. This results in a polymer with a broader molecular weight distribution compared to traditional unimodal HDPE. The combination of different molecular weights offer advantages, such as improved mechanical properties and processability, among others, for use in blow and rotational molded products, pipe and tubing applications along with film and packaging applications.

An important consideration in the production of bimodal HDPE is the cost-in-use (CIU) of the catalyst used to make the bimodal HDPE. The CIU is effectively the cost of the catalyst per unit weight of the polymer produced. The CIU is usually expressed in either cents-per-pound (cpp) or $/ton. CIU is intimately linked to the productivity of a catalyst and becomes more economically advantageous when the productivity of the catalyst increases. Catalysts for bimodal polymer production (e.g., bimodal HDPE), however, continue to be CIU challenged due in large part to the low productivity of the high molecular weight portion of the bimodal polymer. The challenge in the art is to achieve improvements in the production of bimodal HDPE without changing the polymer/product produced. In other words, there was a need in the art to improve the productivity of catalysts for bimodal polymer production without changing the bimodal polymer and thus the produced product.

### SUMMARY

Various methods can be employed to adjust or control polymerization reaction conditions. Adjusting polymerization reaction conditions can alter catalyst productivity. However, altering reaction conditions may have other unintended consequences. For instance, altering reaction conditions can also alter various polymer properties (e.g., Mn, Mw, MWD, density, etc.), impart operability issues (e.g., agglomeration, sheeting, etc.), increase catalyst residue in the polymer, and/or increase production cost. Thus, there remains a need for methods of adjusting or controlling catalyst productivity which do not require changing polymerization reaction conditions.

The present disclosure provides technical solutions to the above technical problems by employing an effective amount of an activity-enhancing compound, as discussed herein, to alter the molecular structure of at least a non-metallocene precatalyst in a productivity enhanced bimodal catalyst. The activity-enhancing compound can be introduced during the preparation of a solid or a spray dried form of the productivity enhanced bimodal catalyst and/or a catalyst system (e.g., a multimodal catalyst system). The productivity enhanced bimodal catalyst and/or a catalyst system (e.g., a multimodal catalyst system) including the productivity enhanced bimodal catalyst can be employed in a polymerization reactor to make polymers at an improved level of productivity, as detailed herein, and yet the productivity enhanced bimodal catalysts are easily and inexpensively prepared and still make polymer with desired properties (e.g., molecular weight, molecular weight distribution, etc.). This result is not predictable.

As provided herein, the present disclosure provides for changing the composition of matter for a catalyst system (e.g., a non-metallocene precatalyst and a metallocene precatalyst as provided herein) with an activity-enhancing compound to produce a productivity enhanced bimodal catalyst.

The results/features caused by the inclusion of the activity-enhancing compound to produce the productivity enhanced bimodal catalyst of the present disclosure include (a)-(g):
(a) Increased productivity as seen by the increase in productivity of both the high molecular weight and low molecular weight components of the productivity enhanced bimodal catalyst (shown in the Examples section by the comparison of the productivity of the productivity enhanced bimodal catalyst to the comparative catalysts system that do not include the activity-enhancing compound.
(b) The productivity enhanced bimodal catalyst demonstrates a higher overall productivity, whereas controls with the activity-enhancing compound and metallocene catalyst only show a decrease in productivity (e.g., the direct combination of the metallocene catalyst and the activity-enhancing compound is detrimental).
(c) The activity-enhancing compound functions by chemically modifying the active high molecular weight (non-metallocene) component, which is accomplished by contacting the high molecular weight non-metallocene precatalyst with activator (e.g., methylaluminoxane, (“MAO”)) and the activity-enhancing compound in solution, slurry, or suspension in an inert hydrocarbons (other components of the bimodal catalyst system may or may not be present). As described in (b) the activity-enhancing compound has a negative impact on metallocene productivity and also no impact on the metallocene kinetics.
(d) The productivity enhanced bimodal catalyst operates effectively with a decreased trim/cat ratio, which is a surprising and unpredictable feature. This is demonstrated in the Examples section by the increase in the flow index (FI₂₁) of the polymer, where it is believed the activity-enhancing compound works on increasing the productivity of the HMW component that increases the Mw thereby decreasing the FI₂₁. Since the productivity increases and the FI₂₁ decreases this means both the non-metallocene and metallocene catalyst components of the productivity enhanced bimodal catalyst of the present disclosure are positively impacted (directly or indirectly) by the activity-enhancing compound. This indicates that there may be s a secondary effect on the metallocene catalyst component where its productivity also increases (possibly even more than the non-metallocene catalyst based on changes to the polymer data). It is believed this is caused by the indirect impact of the activity-enhancing compound in increasing the productivity of the metallocene component(s). From single catalyst work there should be no benefit to the metallocene (even a negative impact in some cases), so the fact that less metallocene catalyst is needed in the productivity enhanced bimodal catalyst of the present disclosure despite having more productivity from the metallocene catalyst means there is more productivity for the metallocene low molecular weight polymer production.
(e) The bimodal HDPE produced by the productivity enhanced bimodal catalyst in the semi-batch reactor method (specifically when no trim is used to adjust the ratio of LMW:HMW components) of the present disclosure has a lower Mw and Mn molecular weight from an increased LMW polymer component in the bimodal HDPE. In addition, the bimodal HDPE produced by the productivity enhanced bimodal catalyst has increased crystallinity, as measured by an increase in the enthalpy of melting of the bimodal HDPE polymer.
(f) The productivity enhanced bimodal catalyst also displays an improved heat control. The presence of the activity-enhancing compound of the present disclosure decreases the overall heat generated by the productivity enhanced bimodal catalyst despite having increased productivity. Heat is generated through the heat of polymerization, less heat associated with less productivity is not surprising. Less heat with more productivity is a surprising feature of the activity-enhancing compound. In the Examples section, this is measured indirectly through the maximum internal reactor temperature (during the semi-batch reactor test method) and the time it takes to reach the maximum temperature. For the productivity enhanced bimodal catalyst the maximum reactor temperature is lower and the maximum takes longer time to reach, relative to the comparative system. This surprising feature also allows for less induced condensing agent (ICA) to be used (e.g., isopentane, iC5) in, for example, a fluidized bed in forming the bimodal HDPE polymer as there is less heat that needs to be removed from the fluidized bed of the polymerization reactor.
(g) The productivity enhanced bimodal catalyst of the present disclosure surprisingly attenuates light-off kinetics of the polymerization reaction forming the bimodal HDPE and also allows for a longer lifetime of the productivity enhanced bimodal catalyst. Ethylene uptake curves for the productivity enhanced bimodal catalyst may also demonstrate decreases initial ethylene uptake, which can be quantified as lower ratio of ethylene uptake by a certain point. This results in a delayed or slow light. The overall ethylene uptake for the productivity enhanced bimodal catalyst decays more slowly, i.e. there is increased catalyst lifetime, which lends to increased productivity for processes with longer residence times. This can also be quantified by ratios of percent ethylene uptake to time points of the reaction.

As discussed more fully herein, the productivity enhanced bimodal catalyst is comprised of at least two catalyst systems described as (i) a solid catalyst system (alternatively a spray dried catalysts system) and (ii) the effective catalyst system. The solid catalyst system for the productivity enhanced bimodal catalyst can be comprised of the non-metallocene catalyst, the metallocene catalyst, the activity-enhancing compound, an activator and a support. Additional metallocene catalysts, as discussed herein, can also be used in the solid catalyst system of the productivity enhanced bimodal catalyst. These components can be mixed in an inert hydrocarbon solvent, as provided herein, and then spray dried to give the solid catalyst system of the productivity enhanced bimodal catalyst. The effective catalyst system for the solid catalyst system of the productivity enhanced bimodal catalyst can include a slurry (e.g., mineral oil and optionally an inert hydrocarbon) of the solid (or spray dried) catalyst system of the productivity enhanced bimodal catalyst being contacted (e.g., preferably in-line to the polymerization reactor) with a trim solution of a metallocene compound, as discussed herein, in inert hydrocarbon. The ratio of trim to the solid catalyst system of the productivity enhanced bimodal catalyst takes on a range and can be adjusted to make different bimodal products or to adapt to process needs.

### BRIEF DESCRIPTION OF DRAWINGS

FIG. 1 provides ethylene uptake versus time curves for Examples and Comparative Examples according to an embodiment of the disclosure.

FIG. 2 provides ethylene uptake versus time curves for Examples and Comparative Examples according to an embodiment of the disclosure.

FIG. 3 provides temperature profiles for Examples and Comparative Examples according to an embodiment of the disclosure.

FIG. 4 provides internal temperature profiles for Examples and Comparative Examples according to an embodiment of the disclosure.

### DETAILED DESCRIPTION

The entire contents of the Summary section are incorporated in the Detailed Description by reference. Additional embodiments follow; some are numbered for easy reference.

Aspect 1. A method of making a productivity enhanced bimodal catalyst, the method comprising: combining a non-metallocene precatalyst, a metallocene precatalyst, an effective amount of an activator to activate the non-metallocene precatalyst and the metallocene precatalyst, and an effective amount of an activity-enhancing compound into the productivity enhanced bimodal catalyst; where the activity-enhancing compound is of Formula (A):

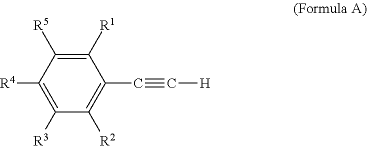

where each of R⁵, R⁴ and R³ independently is H, a halogen, a (C₁-C₂₀)hydrocarbyl, or a (C₁-C₂₀)heterohydrocarbyl; with the proviso that at least one of R⁵ and R³ is a halogen or a haloalkyl; where each of R² and R¹ independently is H, a halogen, a (C₁-C₂₀)hydrocarbyl or a (C₁-C₂₀)heterohydrocarbyl, where each (C₁-C₂₀)hydrocarbyl or (C₁-C₂₀)heterohydrocarbyl independently is unsubstituted or substituted with from 1 to 4 substituent groups R^{S}; where each substituent group R^{S} is independently selected from halogen, unsubstituted (C₁-C₅)alkyl, —C≡CH, —OH, (C₁-C₅)alkoxy, —C(═O)-(unsubstituted (C₁-C₅)alkyl), —NH₂, —N(H)(unsubstituted (C₁-C₅)alkyl), —N(unsubstituted (C₁-C₅)alkyl)₂, —COOH, —C(═O)—NH₂, —C(═O)—N(H)(unsubstituted (C₁-C₅)alkyl), —C(═O)—N(unsubstituted (C₁-C₅)alkyl)₂, —S-(unsubstituted (C₁-C₅)alkyl), —S(═O)₂-(unsubstituted (C₁-C₅)alkyl), —S(═O)₂—NH₂, —S(═O)₂—N(H)(unsubstituted (C₁-C₅)alkyl), —S(═O)₂—N(unsubstituted (C₁-C₅)alkyl)₂, —C(═)S-(unsubstituted (C₁-C₅)alkyl) and —COO(unsubstituted (C₁-C₅)alkyl); and where the metallocene precatalyst is of Formula (B):

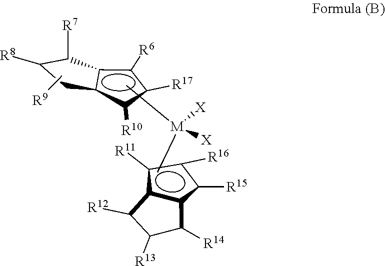

where M is a Group 4 element, each X is, independently, a hydride group, an amide, a benzyl group, a methyl group, a chloro group, a fluoro group, a methylene(trimethylsilyl) group, a hydrocarbyl group, or a heterohydrocarbyl group; each of R⁶, R¹⁰, R¹¹ and R¹⁵ independently is a (C₁-C₁₀)hydrocarbyl, or a (C₁-C₁₀)heterohydrocarbyl; and each of R⁷, R⁸, R⁹, R¹², R¹³, R¹⁴, R¹⁶ and R¹⁷ independently is a H, a (C₁-C₁₀)hydrocarbyl, or a (C₁-C₁₀)heterohydrocarbyl.

Aspect 2. The method of aspect 1 where each of R⁵ and R³ is independently a halogen or haloalkyl; each of R² and R¹ is H; R⁴ is selected from H, hydrocarbyl, halogen and haloalkyl.

Aspect 3. The method of aspect 1 where the activity-enhancing compound is 3,5-difluoro-1-ethynylbenzene:

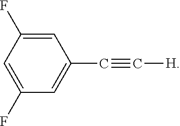

Aspect 4. The method of aspect 1 where the one of R⁵ and R³ is halogen or haloalkyl and the other is hydrogen.

Aspect 5. The method of aspect 1 where the activity-enhancing compound is 3-fluoro-1-ethynylbenzene or 3,4-difluoro-1-ethynylbenzene:

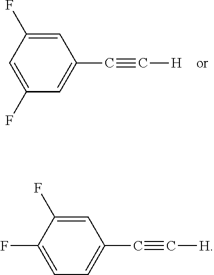

Aspect 7. The method of any one of aspects 1 to 5 where each of R⁷, R⁸, R⁹, R¹², R¹³, R¹⁴, R¹⁶ and R¹⁷ is H; each of R⁶, R¹⁰, R¹¹ and R¹⁵ is a (C₁-C₅)hydrocarbyl; M is Zr and each X is a chloro group or a (C₁-C₃)hydrocarbyl.

Aspect 7. The method of aspect 6 where each of R⁶, R¹⁰, R¹¹, and R¹⁵ is a C₁ hydrocarbyl and each X is a chloro group or a methyl group.

Aspect 8. The method of any one of aspects 1 to 7 where the metallocene precatalyst of Formula (B) is selected from the group consisting of Compound (1):

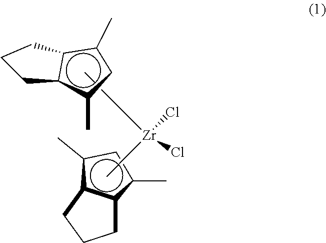

### and Compound (2):

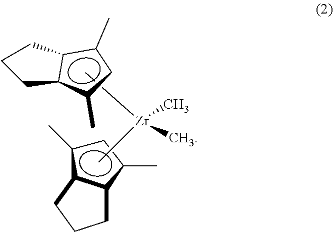

Aspect 9. The method of any one of aspects 1 to 8 where the method further comprises combining the non-metallocene precatalyst, the metallocene precatalyst, the effective amount of the activator, the effective amount of the activity-enhancing compound, a support material, and an inert hydrocarbon solvent to make a mixture, and removing the inert hydrocarbon solvent from the mixture so as to give the productivity enhanced bimodal catalyst disposed on the support material.

Aspect 10. The method of any one of aspects 1 to 9 where the non-metallocene precatalyst is a non-metallocene precatalyst of Formula (C)

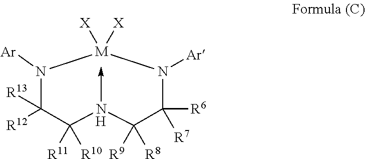

where M is a group 4 element, each of R⁶-R¹³ are independently a hydrogen or a methyl group, Ar is an aryl group or a substituted aryl group, Ar′ is an aryl group or a substituted aryl group, and each X is, independently, a hydride group, an amide, a benzyl group, a methyl group, a chloro group, a fluoro group, a methylene(trimethylsilyl) group, a hydrocarbyl group, or a heterohydrocarbyl group.

Aspect 11. The method of any one of aspects 1 to 10 where the non-metallocene precatalyst of Formula (C) is of compound (3):

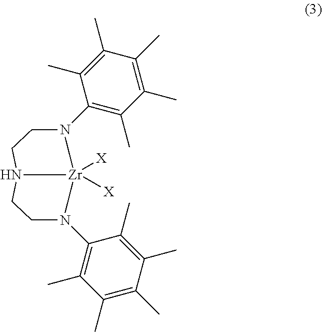

where each X is, independently, a hydride group, an amide, a benzyl group, a methyl group, a chloro group, a fluoro group, methylene(trimethylsilyl) group, a hydrocarbyl group, or a heterohydrocarbyl group.

Aspect 12. The method of aspect 11 the non-metallocene precatalyst of Formula (C) is of compound (4):

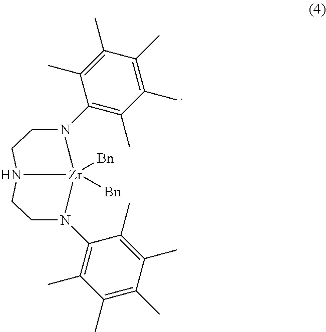

Aspect 13. The method of any one of aspects 1 to 12 where the metal of the non-metallocene precatalyst is M, where the activator is an organoaluminum compound, and where the effective amount of the activator is an Al/M molar ratio of from 0.5 to 10,000, alternatively from 0.95 to 200, alternatively from 1.0 to 150, alternatively from 10 to 100; and/or where the effective amount of the activity-enhancing compound comprises a molar ratio of activity-enhancing compound-to-non-metallocene precatalyst (AEC/NMC molar ratio) of from 0.2:1.0 to 50.0:1.0, alternatively from 0.9:1.0 to 20.0:1.0, alternatively from 0.9:1.0 to 11:1.0, alternatively from 0.95:1.0 to 6:1.0, alternatively from 0.95:1.0 to 1.2:1.0.

Aspect 14. The method of any one of aspects 1 to 13, including using the metallocene precatalyst of Compound (2):

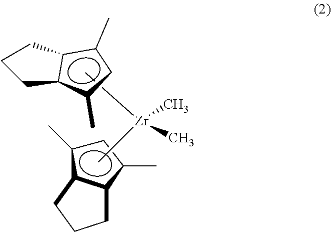

as a trim catalyst.

Aspect 15. A productivity enhanced bimodal catalyst made by the method of any one of aspects 1 to 14.

Aspect 16. A method of feeding a productivity enhanced bimodal catalyst to a slurry-phase, solution-phase, or gas-phase polymerization reactor containing an olefin monomer and a moving bed of polyolefin polymer, the method comprising making the productivity enhanced bimodal catalyst outside of the reactor and according to the method of any one of aspects 1 to 14, and feeding the productivity enhanced bimodal catalyst in neat form or as a solution or slurry thereof in an inert hydrocarbon liquid or mineral oil through a feed line free of olefin monomer into the slurry-phase, solution-phase, or gas-phase polymerization reactor.

Aspect 17. The method of aspect 16, further including using the metallocene precatalyst of Compound (2):

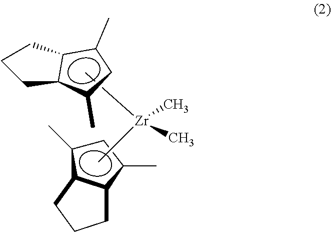

as a trim catalyst with the productivity enhanced bimodal catalyst of any of aspects 1-14 in a slurry-phase, solution-phase, or gas-phase polymerization reactor.

Aspect 18. The catalyst of the method of any of aspects 16 to 17 such that the productivity enhanced bimodal catalyst has a decreased trim requirement compared to the bimodal without an activity enhancing compound, which can be measured in a continuous process by a decreased amount of trim in moles relative to the base catalyst, or an increased activity in lb PE/mol of the low molecular weight metallocene catalyst, which is accompanied by an increase in activity in lb PE/mol of the high molecular weight non-metallocene catalysts. The increase in activity may be from 5% to 100%, or from 5% to 50%, or from 10% to 90%, or from 10% to 50%, or from 20% to 40%, or from 10% to 25%.

Aspect 19. The method of any one of aspects 15 to 17 further including using a continuity additive with the productivity enhanced bimodal catalyst in the slurry-phase, solution-phase, or gas-phase polymerization reactor.

Aspect 20. The method of any of aspects 1-19 of making a productivity enhanced bimodal catalyst with an activity enhancing compound such that the kinetics are improved which can be measured by the semi-batch reactor test method by showing a decrease in the maximum reactor temperature or independently by the activity enhancing index, AEI, as given by Formula (I):

$$Additive effectiveness index at time t , AIE ( t ) = \frac{Additive Catalyst ζ ( t )}{Catalyst with no additive ζ ( t )} \qquad ( I )$$

which can be measured by the semi-batch reactor test described in the Examples and t is the time given in hours of the batch reactor test, ζ(t) is the measured ethylene uptake, or consumption of the catalyst, and the additive catalyst refers to the productivity enhanced bimodal catalyst and the catalyst with no additive refers to the bimodal catalyst without the activity enhancing compound; and the AEI(0.3) refers to the activity enhancing index at 0.3 hours and AEI(0.3)>2.0; alternatively the AEI(0.3)>4.0.

Aspect 21. The method of aspect 20 where the continuity additive is CA-300.

Aspect 22. A multimodal catalyst system comprising the productivity enhanced bimodal catalyst made by the method of any one of Aspects 1 to 16, and at least one second catalyst selected from a different metallocene catalyst and a different non-metallocene catalyst.

Aspect 23. A method of making a polyolefin polymer, the method comprising contacting at least one 1-alkene monomer with the productivity enhanced bimodal catalyst made by the method of any one of aspects 1 to 16, or the multimodal catalyst system of aspect 22, in a slurry-phase, solution-phase, or gas-phase polymerization reactor under polymerizing conditions, thereby making the polyolefin polymer.

Aspect 24. A polyolefin polymer made by the method of making a polyolefin polymer of aspect 23.

Aspect 25. A manufactured article made from the polyolefin polymer of aspect 24.

Aspect 26. The method of Aspect 19, where the high molecular weight (HMW) catalyst component, i.e., the non-metallocene catalyst component, has an increased activity (given in lb PE/mol HMW catalyst) of >20%.

Aspect 27. The method of Aspect 19, where the high molecular weight (HMW) catalyst component, i.e., the non-metallocene catalyst component, has an increased activity (given in lb PE/mol HMW catalyst) of >20%.

Aspect 28. The method of Aspect 19, where the HMW catalyst component, i.e., the non-metallocene catalyst component, has an increased activity (given in lb PE/mol HMW catalyst) of >40%.

Aspect 29. The method of Aspect 19, where the low molecular weight (LMW) catalyst component, i.e., the metallocene catalyst component, has an increased activity (given in lb PE/mol HMW catalyst) of >25%.

Aspect 30. The method of Aspects 19 to 29, where the LMW catalyst component, i.e., the metallocene catalyst component, has an increased activity (given in lb PE/mol HMW catalyst) of >50%.

Aspect 31. The method of any one of Aspects 26 to 30, where the activities given in pounds polyethylene per mole of molecular catalyst component of both the HMW (i.e., non-metallocene) and LMW (i.e., metallocene) catalyst components have increased by >20%.

Aspect 32. The method of any one of Aspects 26 to 31, where the activities given in pounds polyethylene per mole of molecular catalyst component of both the HMW (i.e., non-metallocene) and LMW (i.e., metallocene) catalyst components have increased by >40%.

Aspect 33. The method of Aspect 19, where a ratio of the trim catalyst to dry catalyst is decreased compared to a bimodal catalyst without the activity-enhancing compound to produce the same polymer and given that the concentrations of a feed of the trim catalyst and the feed of the bimodal catalyst are equivalent.

Aspect 34. The method of Aspect 19, where less trim catalyst measured in terms of moles of trim catalyst or grams of trim catalyst are required to make the same polymer with the productivity enhanced bimodal catalyst compared to the bimodal catalyst without the activity-enhancing compound.

Aspect 35. The method of any one of Aspects 19 to 34, where the productivity enhanced bimodal catalyst has an increased catalyst lifetime as shown by having an increased HMW catalyst activity of >50% when the residence time is >4 hours compared to the bimodal catalyst without the activity-enhancing compound.

Aspect 36. The method of any one of Aspects 19 to 34, where the productivity enhanced bimodal catalyst has an increased catalyst lifetime as shown by having an increased HMW catalyst activity of >50% and an increased LMW catalyst activity of >50% when the residence time is >4 hours compared to the bimodal catalyst without the activity-enhancing compound.

Aspect 37. The method of any one of Aspects 19 to 34, where the productivity enhanced bimodal catalyst has a higher or equal productivity than the bimodal catalyst without the activity-enhancing compound under conditions where the amount of induced condensing agent (ICA) is decreased by more than 50%.

Aspect 38. The method of Aspect 37, where the induced condensing agent is isopentane.

Aspect 39. The method of Aspect 38, where the isopentane feed is <10 mol %.

Aspect 40. The method of Aspect 38, where the isopentane feed is <5 mol %.

Aspect 41. The method of any one of Aspects 1 to 40, where the productivity enhanced bimodal catalyst can be characterized by an additive effectiveness index (AEI), as given by Formula (I):

$$Additive effectiveness index at time t , AIE ( t ) = \frac{Additive Catalyst ζ ( t )}{Catalyst with no additive ζ ( t )} \qquad ( I )$$

which can be measured by the semi-batch reactor test described in the embodiments and t is the time given in hours of the batch reactor test.

Aspect 42. The method of Aspect 41, where the AEI(t) at t=0.3 hours is greater than 2.0: AEI (0.3)>2.0.

Aspect 43. The method of Aspect 41, where the AEI(t) at t=0.9 hours is greater than 2.0: AEI(0.9)>2.0.

Aspect 44. The method of Aspect 41, where the AEI(t) at t=0.1 hours is greater than 1.3: AEI(0.1)>1.3.

Aspect 45. The method of Aspect 41, where the AEI(t) at t=0.3 hours is greater than 4.0: AEI(0.3)>4.0.

Aspect 46. The method of Aspect 41, where the AEI(t) at t=0.9 hours is greater than 5.0: AEI(0.9)>5.0.

Aspect 47. The method of Aspect 41, where the AEI(t) at t=0.1 hours is greater than 1.6: AEI(0.1)>1.6.

Aspect 48. The method of any one of Aspects 1-47, where the bimodal catalyst containing the activity-enhancing compound of Formula (A) has a longer catalyst lifetime than the same bimodal catalyst that does not containing activity-enhancing compound of formula (A).

Aspect 49. The method of Aspect 48, where the lifetime of the bimodal catalyst with activity-enhancing compound of formula (A) is quantified by the ethylene uptake from the semi-batch reactor test method as provided herein, where the maximum instantaneous ethylene uptake is less than that of the bimodal catalyst without the activity-enhancing compound of formula (A), but the ethylene uptake at 0.1 hours, 0.3 hours, and 0.9 hours is greater than that of the bimodal catalyst without the activity-enhancing compound of formula (A).

Aspect 50. The method of Aspect 49, where the bimodal catalyst with activity-enhancing compound of formula (A) has a larger ζ(t), which is defined as the ratio of ethylene at a given time t to the maximum ethylene uptake ratio for the catalyst using the semi-batch test method, as provided herein, than the same bimodal catalyst without the activity-enhancing compound of formula (A) under the same test conditions.

Productivity Enhanced Bimodal Catalyst. The method of making a productivity enhanced bimodal catalyst comprises combining in any order constituents consisting essentially of a non-metallocene precatalyst, a metallocene precatalyst, an effective amount of an activator, and an effective amount of an activity-enhancing compound under conditions effective for the activator and the activity-enhancing compound to activate the non-metallocene precatalyst and the metallocene precatalyst into the productivity enhanced bimodal catalyst, thereby making the productivity enhanced bimodal catalyst. The activity-enhancing compound may be of Formula (A), as detailed herein. The metallocene precatalyst may be a metallocene precatalyst of Formula (B), as detailed herein. The non-metallocene precatalyst may be a non-metallocene precatalyst of Formula (C), as detailed herein. In some embodiments metal M for either the metallocene precatalyst of Formula (B) and/or the non-metallocene precatalyst of Formula (C) is Zr or Hf; alternatively M is Zr or Ti; alternatively M is Ti or Hf; alternatively M is Zr; alternatively M is Hf; alternatively M is Ti.

Embodiments of the method of making may comprise any one of synthesis schemes 1 to 15.

Synthesis Scheme 1: Step (a) non-metallocene precatalyst+metallocene precatalyst+excess activator→intermediate mixture of activated non-metallocene catalyst+activated metallocene catalyst+leftover activator. Step (b) intermediate mixture+effective amount of activity-enhancing compound→productivity enhanced bimodal catalyst+the leftover activator.

Synthesis Scheme 2: Step (a)+non-metallocene precatalyst+metallocene precatalyst+effective amount of activity-enhancing compound 4 intermediate non-metallocene precatalyst+intermediate metallocene precatalyst (unreacted mixture or reaction product of non-metallocene precatalyst+metallocene precatalyst+activity-enhancing compound). Step (b) intermediate non-metallocene precatalyst+intermediate metallocene precatalyst+activator (e.g., an alkylaluminoxane such as methylaluminoxane (“MAO”))→productivity enhanced bimodal catalyst.

Synthesis Scheme 3: Step (a) non-metallocene precatalyst+metallocene precatalyst+activator (e.g., an alkylaluminoxane such as methylaluminoxane (“MAO”))→activated non-metallocene catalyst+activated metallocene catalyst. Step (b) activated non-metallocene catalyst+activated metallocene catalyst+effective amount of activity-enhancing compound→productivity enhanced bimodal catalyst.

Synthesis Scheme 4: Step (a) activator (e.g., an alkylaluminoxane such as methylaluminoxane (“MAO”))+effective amount of activity-enhancing compound→intermediate mixture. Step (b) Intermediate mixture+non-metallocene precatalyst+metallocene precatalyst→productivity enhanced bimodal catalyst.

Synthesis Scheme 5: Step (a) activator→non-metallocene precatalyst+metallocene precatalyst←effective amount of activity-enhancing compound (simultaneous but separate additions of activator and activity-enhancing compound to non-metallocene precatalyst+metallocene precatalyst)→productivity enhanced bimodal catalyst. Step (b): none.

Synthesis Scheme 6: Step (a) non-metallocene precatalyst+metallocene precatalyst+support material→supported non-metallocene precatalyst+supported metallocene precatalyst. Step (b) supported non-metallocene precatalyst+supported metallocene precatalyst+an amount of activator→intermediate mixture of activated+supported non-metallocene catalyst+supported metallocene catalyst+leftover activator disposed on (or in equilibrium with) the support material. Step (c) intermediate mixture+effective amount of activity-enhancing compound→productivity enhanced bimodal catalyst disposed on (or in equilibrium with) support material. In some aspects step (a) further includes an inert hydrocarbon solvent and deposition on the support material is performed by evaporating the solvent, alternatively by spray-drying.

Synthesis Scheme 7: Step (a) non-metallocene precatalyst+excess activator (e.g., an alkylaluminoxane such as methylaluminoxane (“MAO”))→intermediate mixture of activated non-metallocene catalyst+leftover activator. Step (b) intermediate mixture+effective amount of activity-enhancing compound→intermediate mixture of reaction product of additive and activated non-metallocene+excess activity-enhancing compound. Step (c) intermediate mixture+metallocene precatalyst→productivity enhanced bimodal catalyst+the leftover activator. Synthesis scheme 7 can be practiced with or without a support as provided herein.

Synthesis Scheme 8: Step (a) non-metallocene precatalyst+excess activator (e.g., an alkylaluminoxane such as methylaluminoxane (“MAO”))+support material→intermediate mixture of activated non-metallocene catalyst+leftover activator+support material. Step (b) intermediate mixture+effective amount of activity-enhancing compound→intermediate mixture of reaction product of additive and activated non-metallocene+excess activity-enhancing compound+support material. Step (c) intermediate mixture+metallocene precatalyst→productivity enhanced bimodal catalyst disposed on (or in equilibrium with) support material. In some aspects step (a) further includes an inert hydrocarbon solvent and deposition on the support material is performed by evaporating the solvent, alternatively by spray-drying.

The amount of activator may be a stoichiometric amount relative to the metal M of the non-metallocene catalyst (e.g., a molar ratio of 1.0 to 1.0); alternatively a less than stoichiometric amount relative thereto (e.g., a molar ratio of from 0.1 to 0.94); alternatively an excess amount (e.g., a molar ratio from 1.1 to 10,000) relative thereto; alternatively the metal of the non-metallocene precatalyst, M, where the activator is an organoaluminum compound, as provided herein, and where the effective amount of the activator is an Al/M molar ratio of from 0.5 to 10,000, alternatively from 0.95 to 200, alternatively from 1.0 to 150, alternatively from 10 to 100; and/or where the effective amount of the activity-enhancing compound comprises a molar ratio of activity-enhancing compound-to-non-metallocene precatalyst (AEC/NMC molar ratio) of from 0.2:1.0 to 50.0:1.0, alternatively from 0.9:1.0 to 20.0:1.0, alternatively from 0.9:1.0 to 11:1.0, alternatively from 0.95:1.0 to 6:1.0, alternatively from 0.95:1.0 to 1.2:1.0. Examples of the support material are alumina and hydrophobized fumed silica; alternatively the hydrophobized fumed silica. The hydrophobized fumed silica may be made by surface-treating an untreated, anhydrous fumed silica with an effective amount of a hydrophobing agent. The hydrophobing agent may be dimethyldichlorosilane, a polydimethylsiloxane fluid, or hexamethyldisilazane; alternatively dimethyldichlorosilane. The hydrophobized fumed silica made by surface-treating an untreated, anhydrous fumed silica with dimethyldichlorosilane may be CABOSIL® TS-610, which is a fumed silica that is surface treated with dimethyldichlorosilane.

Synthesis Scheme 9: Step (a) non-metallocene precatalyst+metallocene precatalyst+effective amount of activity-enhancing compound+support material→intermediate mixture of non-metallocene precatalyst+metallocene precatalyst and activity-enhancing compound disposed on (or in equilibrium with) support material. Step (b) intermediate mixture+activator (e.g., an alkylaluminoxane such as methylaluminoxane (“MAO”))→productivity enhanced bimodal catalyst disposed on (or in equilibrium with) support material. In some aspects step (a) further includes an inert hydrocarbon solvent and deposition on the support material is performed by evaporating the solvent, alternatively by spray-drying.

Synthesis Scheme 10: Step (a) non-metallocene precatalyst+metallocene precatalyst+support material+activator (e.g., an alkylaluminoxane such as methylaluminoxane (“MAO”))→activated and supported non-metallocene catalyst and metallocene catalyst disposed on (or in equilibrium with) support material. Step (b) supported activated non-metallocene catalyst+activated metallocene catalyst+effective amount of activity-enhancing compound→productivity enhanced bimodal catalyst disposed on (or in equilibrium with) support material. In some aspects step (a) further includes an inert hydrocarbon solvent and deposition on the support material is performed by evaporating the solvent, alternatively by spray-drying.

Synthesis Scheme 11: Step (a) activator (e.g., an alkylaluminoxane such as methylaluminoxane (“MAO”))+effective amount of activity-enhancing compound→intermediate solution. Step (b) Intermediate solution+non-metallocene precatalyst+metallocene precatalyst+support material→productivity enhanced bimodal catalyst disposed on (or in equilibrium with) support material. In some aspects step (b) further includes an inert hydrocarbon solvent and deposition on the support material is performed by evaporating the solvent, alternatively by spray-drying.

Synthesis Scheme 12: Step (a) activator→non-metallocene precatalyst+metallocene precatalyst+support material←effective amount of activity-enhancing compound (simultaneous but separate additions of activator and activity-enhancing compound to mixture of non-metallocene precatalyst+metallocene precatalyst+support material)→productivity enhanced bimodal catalyst disposed on (or in equilibrium with) support material. Step (b): none. In some aspects step (a) further includes an inert hydrocarbon solvent and deposition on the support material is performed by evaporating the solvent, alternatively by spray-drying.

Synthesis Scheme 13: Step (a): activator (e.g., an alkylaluminoxane such as methylaluminoxane (“MAO”))+support material (e.g., hydrophobic fumed silica)+inert hydrocarbon solvent→slurry of supported activator disposed on (or in equilibrium with) support material. Step (b): spray-dry slurry of step (a)→spray-dried supported activator disposed on support material in form of a dry powder (e.g., spray-dried MAO on hydrophobic fumed silica as dry powder (“SDMAO” or “sdMAO”). Step (c): mix non-metallocene precatalyst+metallocene precatalyst+spray-dried supported activator of step (b)+inert hydrocarbon solvent→suspension of supported non-metallocene catalyst+supported metallocene precatalyst disposed on (or in equilibrium with) the support material. Step (d): mix suspension from step (c) with effective amount of an activity-enhancing compound→suspension of a supported productivity enhanced bimodal catalyst disposed on (or in equilibrium with) the support material in inert hydrocarbon solvent. Optional step (e): remove inert hydrocarbon solvent from the suspension of supported productivity enhanced bimodal catalyst→supported productivity enhanced bimodal catalyst disposed on support material in the form of a dry powder. Step (e) may be performed by conventional evaporating of the inert hydrocarbon solvent from the suspension from step (d) or by spray-drying the suspension from step (d).

Synthesis Scheme 14: Step (a): activator (e.g., an alkylaluminoxane such as methylaluminoxane (“MAO”))+support material (e.g., hydrophobic fumed silica)+inert hydrocarbon solvent→slurry of supported excess activator disposed on (or in equilibrium with) support material in inert hydrocarbon solvent. Step (b): to slurry of Step (a) mix non-metallocene precatalyst→slurry of supported activated non-metallocene catalyst disposed on (or in equilibrium with) support material and supported excess activator disposed on (or in equilibrium with) support material in inert hydrocarbon solvent. Step (c): to slurry of Step (b) add effective amount of an activity-enhancing compound→slurry of chemically modified non-metallocene catalyst disposed on (or in equilibrium with) support material and supported excess activator disposed on (or in equilibrium with) support material in inert hydrocarbon solvent. Step (d) to slurry of Step (c) with+metallocene precatalyst→slurry of supported productivity enhanced bimodal catalyst disposed on (or in equilibrium with) the support material and supported excess activator disposed on (or in equilibrium with) support material in inert hydrocarbon solvent. Step (e): remove inert hydrocarbon solvent from the slurry of supported productivity enhanced bimodal catalyst→supported productivity enhanced bimodal catalyst disposed on support material in the form of a dry powder. Step (e) may be performed by conventional evaporating of the inert hydrocarbon solvent from the suspension from step (d) or by spray-drying the suspension from step (d).

Synthesis Scheme 15: Making a multimodal catalyst system comprising the productivity enhanced bimodal catalyst and a different catalyst (e.g., a metallocene catalyst) spray-dried on a silica support: Step (a) non-metallocene precatalyst+metallocene precatalyst+support material+activator (e.g., an alkylaluminoxane such as methylaluminoxane (“MAO”))→activated non-metallocene catalyst+activated metallocene catalyst disposed on (or in equilibrium with) support material. Step (b) supported activated non-metallocene catalyst+supported activated metallocene catalyst+effective amount of activity-enhancing compound→productivity enhanced bimodal catalyst disposed on (or in equilibrium with) support material (e.g., a spray-dried support material). Step (c) adding a different catalyst and/or precatalyst that is added with activator or subsequently contacted with activator to form a different catalyst to the productivity enhanced bimodal catalyst disposed on (or in equilibrium with) the support material to give the multimodal catalyst system. In some aspects step (a) further includes an inert hydrocarbon solvent and deposition on the support material is performed by evaporating the solvent, alternatively by spray-drying. For example, slurry support material (e.g., fumed silica) and MAO in a solvent (e.g., toluene). Then add non-metallocene precatalyst. Mix for a period of time (e.g., 1 hour). Then add activity-enhancing compound. Mix for another period of time (e.g., 1 hour). Then add a second different precatalyst (e.g., a metallocene precatalyst). Spray dry resulting mixture.

The multimodal catalyst system may be fed into the gas-phase polymerization reactor. If desired an additional quantity of the productivity enhanced bimodal catalyst or an additional quantity of the second precatalyst (e.g., a metallocene precatalyst) may be separately fed into the reactor as a solution thereof in an inert hydrocarbon solvent, where it contacts the multimodal catalyst system. Such a separate catalyst and/or precatalyst solution is sometimes called a trim catalyst. Alternatively, the multimodal catalyst system may be contacted with a feed of the trim catalyst in a feed line heading into the reactor. In other embodiments the multimodal catalyst system such as a trimodal catalyst system may be made in situ in a gas-phase polymerization reactor by adding the productivity enhanced bimodal catalyst and at least one second catalyst and/or precatalyst separately into the reactor, where they contact each other, thereby making the multimodal catalyst system in situ in the reactor.

The method of any one of the above aspects may further comprise a step of transferring polymer granules, made in the gas-phase, solution-phase, or slurry-phase polymerization reactor and containing in the granules fully-active productivity enhanced bimodal catalyst, into a (second) gas phase polymerization reactor.

Activity-Enhancing Compound. The activity-enhancing compound may be of Formula (A), as detailed herein. As detailed herein, the activity-enhancing compound of Formula (A) surprisingly and beneficially improves productivity, and does not function as a poison to the productivity enhanced bimodal catalyst, and in particular the non-metallocene catalyst, as may have been perceived be a skilled person viewing the organic compound of Formula (A) in the absence of Applicant's surprising discovery herein. The compound of Formula (A) is an alkyne. The activity-enhancing compound is free of a vinyl functional group (i.e., lacks a group of formula —C(H)═CH₂). For the present disclosure, the activity-enhancing compound is of Formula (A):

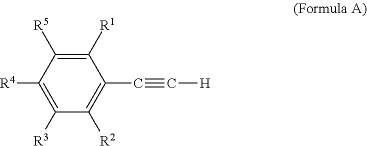

where each of R⁵, R⁴ and R³ independently is H, a halogen, or a (C₁-C₂₀)hydrocarbyl, or a (C₁-C₂₀)heterohydrocarbyl, with the proviso that at least one of R⁵ and R³ is a halogen or a haloalkyl; where each of R² and R¹ independently is H, a halogen, or a (C₁-C₂₀)hydrocarbyl or a (C₁-C₂₀)heterohydrocarbyl, where each (C₁-C₂₀)hydrocarbyl or (C₁-C₂₀)heterohydrocarbyl independently is unsubstituted or substituted with from 1 to 4 substituent groups R^{S}; where each substituent group R^{S} is independently selected from halogen, unsubstituted (C₁-C₅)alkyl, —C≡CH, —OH, (C₁-C₅)alkoxy, —C(═O)-(unsubstituted (C₁-C₅)alkyl), —NH₂, —N(H)(unsubstituted (C₁-C₅)alkyl), —N(unsubstituted (C₁-C₅)alkyl)₂, —COOH, —C(═O)—NH₂, —C(═O)—N(H)(unsubstituted (C₁-C₅)alkyl), —C(═O)—N(unsubstituted (C₁-C₅)alkyl)₂, —S-(unsubstituted (C₁-C₅)alkyl), —S(═O)₂-(unsubstituted (C₁-C₅)alkyl), —S(═O)₂—NH₂, —S(═O)₂—N(H)(unsubstituted (C₁-C₅)alkyl), —S(═O)₂—N(unsubstituted (C₁-C₅)alkyl)₂, —C(═)S-(unsubstituted (C₁-C₅)alkyl) and —COO(unsubstituted (C₁-C₅)alkyl).

For the present disclosure, each of R⁵ and R³ in Formula A can be a halogen or haloalkyl. For the present disclosure, each of R² and R¹ can be H. For the present disclosure, R⁴ can be H. For the present disclosure, the activity-enhancing compound can be 3,5-difluoro-1-ethynylbenzene. In addition, for the present disclosure, each of R³ and R⁴ in Formula A can be a halogen or haloalkyl. For the present disclosure, each of R⁵, R² and R¹ can be H. For the present disclosure, the activity-enhancing compound can be 3,4-difluoro-1-ethynylbenzene. In addition, for the present disclosure, R³ in Formula A can be a halogen or haloalkyl. For the present disclosure, each of R⁵, R⁴, R² and R¹ can be H. For the present disclosure, the activity-enhancing compound can be 3-fluoro-1-ethynylbenzene. In addition, for the present disclosure, each of R³, R⁴, and R⁵ in Formula A can be a halogen or haloalkyl. For the present disclosure, each of R² and R¹ can be H. For the present disclosure, the activity-enhancing compound can be 3,4,5-trifluoro-1-ethynylbenzene.

Metallocene Precatalyst. As mentioned, the metallocene precatalyst can be combined with the non-metallocene precatalyst, the effective amount of the activator, and the effective amount of the activity-enhancing compound to activate the metallocene precatalyst and the non-metallocene precatalyst into the productivity enhanced bimodal catalyst. The metallocene precatalyst is a metallocene precatalyst of Formula (B):

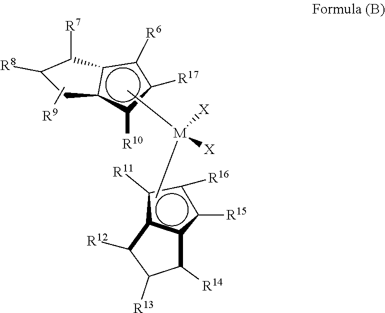

where M is a Group 4 element, each X is, independently, a hydride group, an amide, a benzyl group, a methyl group, a chloro group, a fluoro group, a methylene(trimethylsilyl) group, a hydrocarbyl group, or a heterohydrocarbyl group; each of R⁶, R¹⁰, R¹¹ and R¹⁵ independently is a (C₁-C₁₀)hydrocarbyl, or a (C₁-C₁₀)heterohydrocarbyl; and each of R⁷, R⁸, R⁹, R¹², R¹³, R¹⁴, R¹⁶ and R¹⁷ independently is a H, a (C₁-C₁₀)hydrocarbyl, or a (C₁-C₁₀)heterohydrocarbyl. For the present disclosure, each of R⁷, R⁸, R⁹, R¹², R¹³, R¹⁴, R¹⁶ and R¹⁷ is H; each of R⁶, R¹⁰, R¹¹ and R¹⁵ is a (C₁-C₅)hydrocarbyl; M is Zr and each X is a chloro group or a (C₁-C₃)hydrocarbyl. For the present disclosure, each of R⁶, R¹¹ and R¹³ is C₁ hydrocarbyl and each X is a chloro group or a methyl group. Specific examples of the metallocene precatalyst of Formula (B) include those of compound (1) and compound (2):

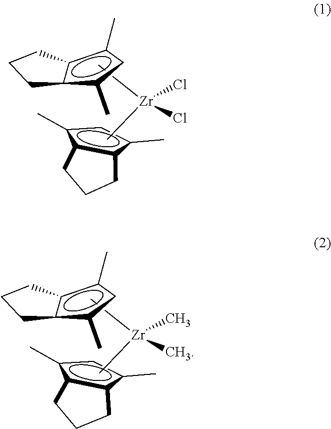

Non-metallocene Precatalyst. As mentioned, the non-metallocene precatalyst can be combined with the metallocene precatalyst, the effective amount of the activator, and the effective amount of an activity-enhancing compound to activate the non-metallocene precatalyst and the metallocene precatalyst into the productivity enhanced bimodal catalyst. The non-metallocene precatalyst is a non-metallocene precatalyst of formula (C)

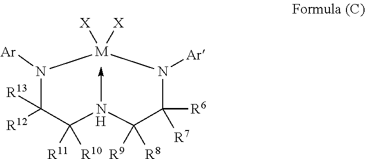

where M is a group 4 element, each of R⁶-R¹³ are independently a hydrogen or a methyl group, Ar is an aryl group or a substituted aryl group, Ar′ is an aryl group or a substituted aryl group, and each X is, independently, a hydride group, an amide, a benzyl group, a methyl group, a chloro group, a fluoro group, a methylene(trimethylsilyl) group, a hydrocarbyl group, or a heterohydrocarbyl group. One or more embodiments provide that each X is independently a silicon-containing alkyl. One or more embodiments provide that each X is independently a tri-hydrocarbylsilylmethyl. One or more embodiments provide that each X is independently a methylene(trimethylsilyl) group. In some embodiments at least one X is ((C₁-C₂₀)alkyl)_{3-g}-(phenyl)_{g}Si— where subscript g is 0, 1, 2, or 3; alternatively, where subscript g is 0 or 1; alternatively 0; alternatively 1. In some aspects at least one X is a (C₆-C₁₂)aryl-((C₀-C₁₀)alkylene)-CH₂ (e.g., benzyl). In some aspects each X is independently a (C₆-C₁₂)aryl-((C₀-C₁₀)alkylene)-CH₂, alternatively one X is a (C₆-C₁₂)aryl-((C₀-C₁₀)alkylene)-CH₂ (e.g., benzyl) and the other X is F, Cl, or methyl; alternatively each X is benzyl. In some aspects each X is benzyl, alternatively one X is a benzyl and the other X is F, Cl, or methyl. In some embodiments at least one X, alternatively each X is a (C₁-C₆)alkoxy-substituted (C₆-C₁₂)aryl or a (C₁-C₆)alkoxy-substituted benzyl.

The activated non-metallocene catalyst is a non-metallocene catalyst for the formula (C-I)

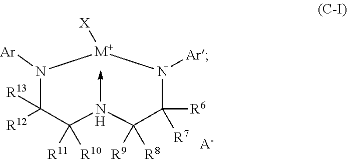

where each of the groups R⁶ to R¹³, Ar, Ar′, and X are as defined for formula (C); where A⁻ is an ion (used to formally balance the positive charge of the metal M).

The ligand in the non-metallocene catalyst that is derived from the activity-enhancing compound may be a group R (“ligand R”). The ligand R may be of formula (D): —C(R¹⁴)═C(X)R¹⁵; where X is as defined for formula (C) and each of R¹⁴ and R¹⁵ of the ligand of formula (D): —C(R⁵)═C(X)R⁶ independently is H or R¹⁶, and where each R¹⁶ of the ligand of formula (D): —C(R⁵)═C(X)R⁶ independently is a (C₁-C₂₀)hydrocarbyl, a (C₁-C₂₀)heterohydrocarbyl, a (C₁-C₂₀)aryl, or a (C₁-C₂₀)heteroaryl with the proviso that each R¹⁶ lacks a non-conjugated carbon-carbon double bond. The (C₁-C₂₀)hydrocarbyl may be unsubstituted and consist of carbon atoms and hydrogen atoms or the (C₁-C₂₀)hydrocarbyl may be substituted and consist of carbon, hydrogen, and one or more halogen atoms. Each halogen atom is independently selected from F, Cl, Br, and I; alternatively from F, Cl, and Br; alternatively from F and Cl; alternatively from F; alternatively from Cl. The unsubstituted (C₁-C₂₀)hydrocarbyl may be an unsubstituted (C₁-C₂₀)alkyl, an unsubstituted (C₃-C₂₀)cycloalkyl, an unsubstituted (C₆-C₁₂)aryl, an unsubstituted ((C₁-C₄)alkyl)₁₋₃-phenyl, or an unsubstituted (C₆-C₁₂)aryl-(C₁-C₆)alkyl. The substituted (C₁-C₂₀)hydrocarbyl may be a monofluoro or difluoro derivative of the aforementioned unsubstituted (C₁-C₂₀)hydrocarbyl, such as 2-(3,4-difluorophenyl)-ethen-1-yl (of formula (A)).

Each (C₁-C₁₉)heterohydrocarbyl, of embodiments of R¹⁴ to R¹⁶ containing the same, may be unsubstituted and consist of carbon atoms, hydrogen atoms, and at least one heteroatom selected from N and O or the (C₁-C₁₇)heterohydrocarbyl may be substituted and consist of carbon atoms, hydrogen atoms, at least one heteroatom selected from N and O, and one or more halogen atoms. The unsubstituted (C₁-C₁₇)heterohydrocarbyl may be (C₁-C₁₉)heteroalkyl, (C₃-C₁₉)heterocycloalkyl, (C₆-C₁₂)heteroaryl, ((C₁-C₄)alkoxy)₁₋₃-phenyl, or (C₆-C₁₂)heteroaryl-(C₁-C₆)alkyl. The substituted (C₁-C₁₇)heterohydrocarbyl may be a monofluoro or difluoro derivative of the aforementioned unsubstituted (C₁-C₁₇)heterohydrocarbyl, such as 2-(3,5-difluorophenyl)-ethen-1-yl (of formula (A)).

The non-metallocene catalyst where the ligand R is derived from the activity-enhancing compound of formula (C-II)

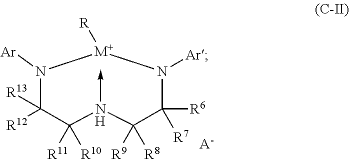

where each of the groups R⁶ to R¹³, Ar, Ar′, and X are as defined for formula (C); where A⁻ is an ion (used to formally balance the positive charge of the metal M); where ligand R may be of formula (D): —C(R¹⁴)═C(X)R¹⁵; where X is as defined for formula (C) and each of R¹⁴ and R¹⁵ of the ligand of formula (D): —C(R⁵)═C(X)R⁶ independently is H or R¹⁶, and where each R¹⁶ of the ligand of formula (D): —C(R⁵)═C(X)R⁶ independently is a (C₁-C₂₀)hydrocarbyl, a (C₁-C₂₀)heterohydrocarbyl, a (C₁-C₂₀)aryl, or a (C₁-C₂₀)heteroaryl with the proviso that each R¹⁶ lacks a non-conjugated carbon-carbon double bond. The (C₁-C₂₀)hydrocarbyl may be unsubstituted and consist of carbon atoms and hydrogen atoms or the (C₁-C₂₀)hydrocarbyl may be substituted and consist of carbon, hydrogen, and one or more halogen atoms. Each halogen atom is independently selected from F, Cl, Br, and I; alternatively from F, Cl, and Br; alternatively from F and Cl; alternatively from F; alternatively from Cl. The unsubstituted (C₁-C₂₀)hydrocarbyl may be an unsubstituted (C₁-C₂₀)alkyl, an unsubstituted (C₃-C₂₀)cycloalkyl, an unsubstituted (C₆-C₁₂)aryl, an unsubstituted ((C₁-C₄)alkyl)₁₋₃-phenyl, or an unsubstituted (C₆-C₁₂)aryl-(C₁-C₆)alkyl. The substituted (C₁-C₂₀)hydrocarbyl may be a monofluoro or difluoro derivative of the aforementioned unsubstituted (C₁-C₂₀)hydrocarbyl, such as 2-(3,5-difluorophenyl)-ethen-1-yl (of formula (A)).

For the present disclosure the non-metallocene catalyst with ligand R derived from the additive catalyst may be given by either or both of formula (C-III) and (C-IV):

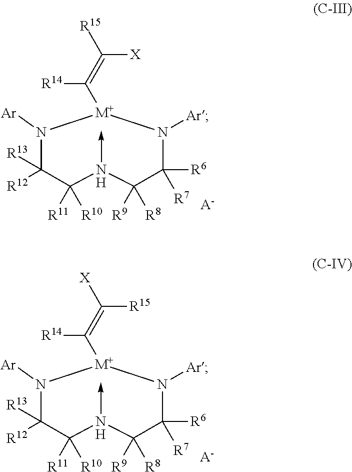

where each of the groups R⁶ to R¹³, Ar, Ar′, and X are as defined for formula (C); where A⁻ is an ion (used to formally balance the positive charge of the metal M); where ligand R may be of formula (D).

The structure of ligand R is different than that of ligand X of the non-metallocene precatalyst and, for that matter, that of anion A⁻ of a non-metallocene catalyst formed from the non-metallocene precatalyst.

For the present disclosure, the first non-metallocene precatalyst of Formula (C) can be of compound (3),

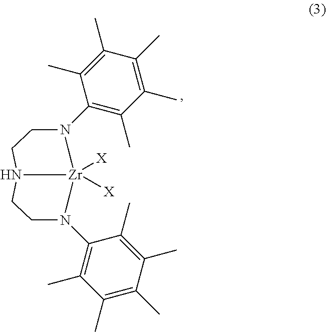

where each X is, independently, a hydride group, an amide, a benzyl group, a methyl group, a chloro group, a fluoro group, a methylene(trimethylsilyl) group, a hydrocarbyl group, or a heterohydrocarbyl group. One or more embodiments provide that each X is independently a silicon-containing alkyl. One or more embodiments provide that each X is independently a tri-hydrocarbylsilylmethyl. One or more embodiments provide that each X is independently a methylene(trimethylsilyl) group. In one or more embodiments the first non-metallocene precatalyst of Formula (C) can be compound (1), and each X can be a benzyl group.

For the various embodiments, the non-metallocene precatalyst of Formula (C) can be of compound (4):

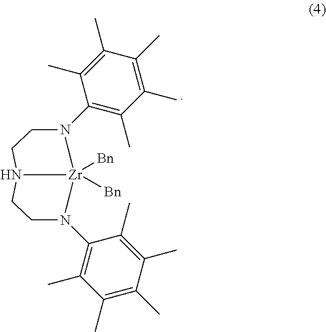

For the various embodiments, the non-metallocene catalyst with a ligand derived from the activity-enhancing compound can be of either or both of compound (4-A) and compound (4-B):

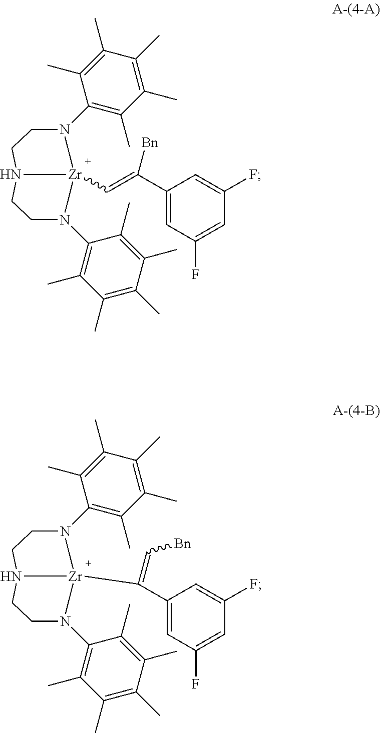

where A⁻ is an ion (used to formally balance the positive charge of the metal M).

Effective amount of the Activity-Enhancing Compound (AEC). A quantity of activity-enhancing compound (AEC) is sufficient to make a productivity enhanced bimodal catalyst. The effective amount of AEC may be expressed in absolute terms compared to the amount of (pre)catalyst metal M or in relative terms compared to the productivity performance or as a combination thereof.

In absolute terms in some embodiments the effective amount of the activity-enhancing compound may be expressed as a molar ratio of moles of activity-enhancing compound to moles of metal M (“MAECₘₒₗ/Mₘₒₗ”), where M is the M of the non-metallocene precatalyst of structural Formula (C), e.g., M is a Group 4 metal. In some embodiments the effective amount of the AEC is expressed as a PAECₘₒₗ/Mₘₒₗ of ≥0.50/1.0, alternatively ≥0.9/1.0; alternatively ≥1.0/1.0; alternatively ≥1.5/1.0; alternatively ≥1.9/1.0; alternatively ≥3/1.0; alternatively ≥5/1.0; alternatively ≥6/1.0; alternatively ≥9/1.0; alternatively ≥10.0/1.0, alternatively ≤10.0/1.0, alternatively ≤20.0/1.0, alternatively ≤30.0/1.0, alternatively ≤40.0/1.0, alternatively ≤50.0/1.0. Said another way, the immediately foregoing embodiments may be described by expressing the effective amount of the AEC as an inverse molar ratio of moles of metal M to moles of activity-enhancing compound (“Mₘₒₗ/MAECₘₒₗ”) as follows: ≤1.0/0.5; alternatively ≤1.0/0.9; alternatively ≤1.0/1.0; alternatively ≤1.0/1.5; alternatively ≤1.0/1.9; alternatively ≤1.0/3.0; alternatively ≤1.0/5.0; alternatively ≤1.0/6.0; alternatively ≤1.0/9.0; alternatively ≤1.0/10.0, alternatively ≤1.0/20.0, alternatively ≤1.0/30.0, alternatively ≤1.0/40.0, alternatively ≤1.0/50.0, respectively. In some embodiments the MAECₘₒₗ/Mₘₒₗ is limited to at most 40/1; alternatively at most 30/1; alternatively at most 20/1; alternatively at most 10.0; alternatively at most 6.0; alternatively at most 5.0; alternatively at most 1.5.

In relative terms of productivity performance; the effective amount of the activity-enhancing compound (AEC) may provide a productivity enhanced bimodal catalyst having improved productivity. In some embodiments the productivity enhanced bimodal catalyst and the effective amount of the AEC is characterized by having improved productivity. In some embodiments the productivity enhanced bimodal catalyst is made from any one of the non-metallocene precatalyst of Formula (C) such as compounds (1), described herein.

Continuity Additive/Static Control Agent. In gas-phase polyethylene production processes, as disclosed herein, it may be desirable to additionally use one or more static control agents to aid in regulating static levels in the reactor. As used herein, a static control agent is a chemical composition which, when introduced into a fluidized bed reactor, may influence or drive the static charge (negatively, positively, or to zero) in the fluidized bed. The specific static control agent used may depend upon the nature of the static charge, and the choice of static control agent may vary dependent upon the polymer being produced and the single site catalyst compounds being used. For example, the use of static control agents is disclosed in European Patent No. 0229368 and U.S. Pat. Nos. 4,803,251; 4,555,370; and 5,283,278, and references cited therein.

Control agents such as aluminum stearate may be employed. The static control agent used may be selected for its ability to receive the static charge in the fluidized bed without adversely affecting productivity. Other suitable static control agents may also include aluminum distearate, ethoxlated amines, and anti-static compositions such as those provided by Innospec Inc. under the trade name OCTASTAT. For example, OCTASTAT 2000 is a mixture of a polysulfone copolymer, a polymeric polyamine, and oil-soluble sulfonic acid.

Any of the aforementioned control agents, as well as those described in, for example, WO 01/44322, listed under the heading Carboxylate Metal Salt and including those chemicals and compositions listed as antistatic agents may be employed either alone or in combination as a control agent. For example, the carboxylate metal salt may be combined with an amine containing control agent (e.g., a carboxylate metal salt with any family member belonging to the KEMAMINE® (available from Crompton Corporation) or ATMER® (available from ICI Americas Inc.) family of products).

Other useful continuity additives include ethyleneimine additives useful in embodiments disclosed herein may include polyethyleneimines having the following general formula:

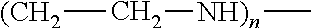

in which n may be from about 10 to about 10,000. The polyethyleneimines may be linear, branched, or hyperbranched (e.g., forming dendritic or arborescent polymer structures). They can be a homopolymer or copolymer of ethyleneimine or mixtures thereof (referred to as polyethyleneimines hereafter). Although linear polymers represented by the chemical formula —[CH₂—CH₂—NH]— may be used as the polyethyleneimine, materials having primary, secondary, and tertiary branches can also be used.

Commercial polyethyleneimine can be a compound having branches of the ethyleneimine polymer. Suitable polyethyleneimines are commercially available from BASF Corporation under the trade name Lupasol. These compounds can be prepared as a wide range of molecular weights and product activities. Examples of commercial polyethyleneimines sold by BASF suitable for use in the present invention include, but are not limited to, Lupasol FG and Lupasol WF. Another useful continuity additive can include a mixture of aluminum distearate and an ethoxylated amine-type compound, e.g., IRGASTAT AS-990, available from Huntsman (formerly Ciba Specialty Chemicals). Other commercial examples of continuity additives include UT-CA-300 (Univation Technologies, LLC), which is a mixture of aluminum distearate and an ethoxylated amine type compound. The mixture of aluminum distearate and ethoxylated amine type compound can be slurried in mineral oil e.g., Hydrobrite 380. For example, the mixture of aluminum distearate and an ethoxylated amine type compound can be slurried in mineral oil to have total slurry concentration of ranging from about 5 wt. % to about 50 wt. % or about 10 wt. % to about 40 wt. %, or about 15 wt. % to about 30 wt. %. Other useful static control agents and additives are disclosed in U.S. Patent Application Publication No. 2008/0045663.

The continuity additives or static control agents may be added to the reactor in an amount ranging from 0.05 to 200 ppm, based on ethylene feed rate or polymer production rate. In some embodiments, the continuity additive may be added in an amount ranging from 2 to 100 ppm, or in an amount ranging from 4 to 50 ppm.

Catalyst productivity. Catalyst productivity of the catalysts provided herein (e.g., the productivity enhanced bimodal catalyst) is determined to be the catalyst's polymerization productivity, expressed as number of pounds dried polyolefin product made per pound of dry bimodal catalyst added (IbPE/Ibcat), or alternatively expressed as number of grams dried polyolefin product made per gram of bimodal catalyst added (gPE/gcat). Catalyst activity may be used interchangeably with catalyst productivity.

Catalyst activity. Catalyst activity of a bimodal catalyst is determined to be the bimodal catalyst's polymerization productivity, expressed as the number of pounds dried polyolefin product in terms made per mole of molecular catalyst component. The catalyst activity may be expressed in terms of both molecular catalyst components of the bimodal catalyst or just one individual molecular catalyst component of the bimodal catalyst, e.g. the activity of the HMW catalyst component or the activity of the non-metallocene catalyst component.

Catalyst structures. Without being bound by theory it is believed that the molecular structure of a non-metallocene catalyst (formed from the non-metallocene precatalyst of Formula (C), the molecular structure of a metallocene precatalyst (formed from the metallocene precatalyst of Formula (B)) and the molecular structure of the productivity enhanced bimodal catalyst may be determined by conventional analytical methods such as nuclear magnetic resonance (NMR) spectroscopy or gas chromatography/mass spectrometry (GC/MS).

Activating step. In some embodiments the method of making productivity enhanced bimodal catalyst further comprises the activating step as a preliminary step, which may be completed before start of the combining step. The activating step comprises contacting the non-metallocene precatalyst of Formula (C) and the metallocene precatalyst of Formula (B) with the activator under the effective activating conditions; contacting with the activity-enhancing compound of Formula (A) makes the productivity enhanced bimodal catalyst. The activating step may be done in various orders, such as by contacting the non-metallocene precatalyst of Formula (C) with the activator under the effective activating conditions and then adding activity-enhancing compound of Formula (A), and then adding the metallocene precatalyst of Formula (B) to the above. The activating step may be performed in the absence of the activity-enhancing compound.

Activator. The activator for activating the metallocene precatalyst of Formula (B) and the non-metallocene precatalyst of Formula (C) may be an alkylaluminoxane, an organoborane compound, an organoborate compound, or a trialkylaluminum compound. The activator may also be a combination of any two or more thereof. For example, the activator may comprise an alkylaluminoxane and an organoborate compound such as a methylaluminoxane and an organoborate having CAS name Amines, bis(hydrogenated tallow alkyl)methyl, tetrakis(pentafluorophenyl)borate (Amines, bis(hydrogenated tallow alkyl)methyl, tetrakis(pentafluorophenyl)borate(1-)).

Alkylaluminoxane: also referred to as alkylalumoxane. A product of a partial hydrolysis of a trialkylaluminum compound. Embodiments may be a (C₁-C₁₀)alkylaluminoxane, alternatively a (C₁-C₆)alkylaluminoxane, alternatively a (C₁-C₄)alkylaluminoxane, alternatively a (C₁-C₃)alkylaluminoxane, alternatively a (C₁-C₂)alkylaluminoxane, alternatively a methylaluminoxane (MAO), alternatively a modified-methylaluminoxane (MMAO). In some aspects the alkylaluminoxane is a MAO. In some embodiments the alkylaluminoxane is supported on untreated silica, such as fumed silica. The alkylaluminoxane may be obtained from a commercial supplier or prepared by any suitable method. Suitable methods for preparing alkylaluminoxanes are well-known. Examples of such preparation methods are described in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081; 5,157,137; 5,103,031; 5,391,793; 5,391,529; and 5,693,838; and in European publications EP-A-0 561 476; EP-B1-0 279 586; and EP-A-0 594-218; and in PCT publication WO 94/10180.

The maximum amount of alkylalumoxane may be selected to be a 5,000-fold molar excess over the precatalysts based on the molar ratio of moles of Al metal atoms in the aluminoxane to moles of metal atoms M (e.g., Ti, Zr, or Hf) in the precatalysts. The minimum amount of activator-to-precatalyst may be a 1:1 molar ratio (Al/M). The maximum may be a molar ratio of Al/M of 150, alternatively 124.

The organoborane compound. A tri(fluoro-functional organo)borane compound ((fluoro-organo)₃B) such as tris(pentafluorophenyl)borane ((C₆F₅)₃B), tris[3,5-bis(trifluoromethyl)phenyl]borane ((3,5-(CF₃)₂—C₆H₃)₃B), or a mixture of any two or more thereof.

The organoborate compound. A tetra(fluoro-functional organo)borate compound ((fluoro-organo)₄B) such as N,N-dimethylanilinium tetrakis(pentafluorophenyl)borate, triphenylcarbenium tetrakis(pentafluorophenyl)borate, N,N-dimethylanilinium tetrakis[3,5-bis(trifluoromethyl)phenyl]borate, or triphenylcarbenium tetrakis[3,5-bis(trifluoromethyl)phenyl]borate, or a mixture of any two or more thereof. The organoborate compound may be a methyldi((C₁₄-C₁₈)alkyl)ammonium salt of tetrakis(pentafluorophenyl)borate, which may be obtained from Boulder Scientific or prepared by reaction of a long chain trialkylamine (Armeen™ M2HT, available from Akzo-Nobel, Inc.) with HCl and Li[B(C₆F₅)₄]. Such a preparation is disclosed in U.S. Pat. No. 5,919,983, Ex. 2. The organoborate compound may be used herein without (further) purification. Also, examples include amines, bis(hydrogenated tallow alkyl)methyl, and tetrakis(pentafluorophenyl)borate.

Trialkylaluminum compounds may be utilized as activators for precatalysts or as scavengers to remove residual water from polymerization reactor prior to start-up thereof. Examples of suitable alkylaluminum compounds are trimethylaluminum, triethylaluminum, triisobutylaluminum, tri-n-hexylaluminum, and tri-n-octylaluminum.

The activator, also known as a cocatalyst, may affect the molecular weight, degree of branching, comonomer content, or other properties of the polyolefin polymer. The activator may enable coordination polymerization or cationic polymerization.

Without being bound by theory it is believed that the choice of activator used to activate the non-metallocene precatalyst and/or the metallocene precatalyst does not influence the structure of the productivity enhanced bimodal catalyst made from the non-metallocene precatalyst and the metallocene precatalyst. That is, the structures of the productivity enhanced bimodal catalyst made using different activators are expected to be identical.

Effective conditions. The reactions described herein (e.g., the combining step, the activating step, the polymerization) independently are conducted under circumstances that allow the activation/reaction to proceed. Examples of effective conditions are reaction temperature, type of atmosphere (e.g., inert atmosphere), purity of reactants, stoichiometry of reactants, agitation/mixing of reactants, and reaction time period. Conditions effective for activating and polymerizing steps may be those described in the art and well-known to the ordinary skilled person. For example, activating effective conditions may comprise techniques for manipulating catalysts such as in-line mixers, catalyst preparation reactors, and polymerization reactors. The activation temperature may be from 0° to 800° C., alternatively from 20° to 50° C. The activation time may be from 10 seconds to 2 hours. Examples of gas-phase polymerizing conditions are described later herein. Effective conditions for the combining step used to make the productivity enhanced bimodal catalyst may comprise a reaction temperature from −50° to 80° C., alternatively from 0° to 50° C., alternatively from −50° to 50° C., alternatively from −50° to 30° C., an inert atmosphere (e.g., nitrogen, helium, or argon gas free of water and 02), reactants that are free of water and 02 and having a purity from 90% to 100%, amounts of reactants for minimizing waste/maximizing product yield, stirring or mixing reactants, and a reaction time period from 1 minute to 24 hours.

Effective reaction conditions for making the productivity enhanced bimodal catalyst. Such conditions may comprise techniques for manipulating air-sensitive and/or moisture-sensitive reagents and reactants such as Schlenk-line techniques and an inert gas atmosphere (e.g., nitrogen, helium, or argon). Effective reaction conditions may also comprise a sufficient reaction time, a sufficient reaction temperature, and a sufficient reaction pressure. Each reaction temperature independently may be from −78° to 120° C., alternatively from −30° to 30° C. Each reaction pressure independently may be from 95 to 105 kPa, alternatively from 99 to 103 kPa. Progress of any particular reaction step may be monitored by analytical methods such as nuclear magnetic resonance (NMR) spectroscopy, mass spectrometry to determine a reaction time that is effective for maximizing yield of intended product. Alternatively, each reaction time independently may be from 30 minutes to 48 hours.

The Metallocene Precatalyst (e.g., the Metallocene Precatalyst of Formula (B)). The metallocene precatalyst may be synthesized according to methods known in the art, including those methods referenced herein. Alternatively, the metallocene precatalyst may be obtained from a precatalyst supplier such as Boulder Scientific. In some aspects the productivity enhanced bimodal catalyst is a product of an activation reaction of an activator, the activity-enhancing compound, and the aforementioned metallocene precatalyst and non-metallocene precatalyst, both as provided herein.

The Non-Metallocene Precatalyst (e.g., the Non-Metallocene Precatalyst of Formula (C)). The non-metallocene precatalyst may be synthesized according to methods known in the art, including those methods referenced herein. Alternatively, the non-metallocene precatalyst may be obtained from a precatalyst supplier such as Boulder Scientific. In some aspects the productivity enhanced bimodal catalyst is a product of an activation reaction of an activator, the activity-enhancing compound, and the aforementioned metallocene precatalyst and non-metallocene precatalyst, both as provided herein.

Polyolefin polymer made by the method of polymerizing. When the 1-alkene monomer is the combination of ethylene and propylene, the polyolefin polymer made therefrom is an ethylene/propylene copolymer. When the 1-alkene monomer is ethylene alone, the polyolefin polymer made therefrom is a polyethylene homopolymer. When the 1-alkene monomer is the combination of ethylene and 1-butene, 1-hexene, or 1-octene, the polyolefin polymer made therefrom is a poly(ethylene-co-1-butene) copolymer, a poly(ethylene-co-1-hexene) copolymer, or a poly(ethylene-co-1-octene) copolymer. In some embodiments the polyolefin polymer made from the 1-alkene monomer is an ethylene-based polymer having from 50 to 100 weight percent (wt %) repeat units derived from ethylene and from 50 to 0 wt % repeat units derived from a 1-alkene monomer selected from propylene, 1-butene, 1-hexene, 1-octene, and the combination of any two or more thereof.

In some embodiments the polymerization method uses the 1-alkene monomer and a comonomer that is a diene monomer (e.g., 1,3-butadiene). When the 1-alkene monomer is a combination of ethylene and propylene and the polymerization also uses a diene monomer, the polyolefin polymer is an ethylene/propylene/diene monomer (EPDM) copolymer. The EPDM copolymer may be an ethylene/propylene/1,3-butadiene copolymer.

The Multimodal (e.g., trimodal) Catalyst System. The multimodal catalyst system comprises the productivity enhanced bimodal catalyst and at least one different olefin polymerization catalyst selected from a metallocene catalyst and a different non-metallocene catalyst. The multimodal catalyst system makes in a single reactor a multimodal polyethylene composition comprising an HMW polyethylene component, a medium MW component, and an LMW polyethylene component.

The method of making the productivity enhanced bimodal catalyst may be performed in the presence of the different olefin catalyst (e.g., a metallocene catalyst or a metallocene precatalyst). However, when performed in the presence of a different precatalyst, the method of activating the non-metallocene precatalyst with an activator further comprises activating the different (e.g., metallocene) precatalyst with a same or different activator. Typically, the method of making the productivity enhanced bimodal catalyst is performed in the absence of a different precatalyst.

Unsupported or supported catalyst. The non-metallocene precatalyst, the non-metallocene catalyst (made from the non-metallocene precatalyst), the metallocene precatalyst, the metallocene catalyst (made from the metallocene precatalyst), the productivity enhanced bimodal catalyst, and the multimodal catalyst system independently may be unsupported or disposed on a solid particulate support material. When the support material is absent, the non-metallocene precatalyst, the non-metallocene catalyst, the metallocene precatalyst, the metallocene catalyst, the productivity enhanced bimodal catalyst, and the multimodal catalyst system may be injected into a slurry-phase, solution-phase, or gas-phase polymerization reactor as a solution in a hydrocarbon solvent. When the non-metallocene precatalyst, the non-metallocene catalyst, the metallocene precatalyst, the metallocene catalyst, the productivity enhanced bimodal catalyst, and the multimodal catalyst system is/are disposed on the support material, they may be injected into the slurry-phase, solution-phase, or gas-phase polymerization reactor as a slurry suspended in the hydrocarbon solvent or as a dry, powder (i.e., dry particulate solid).

The non-metallocene precatalyst, the non-metallocene catalyst (made from the non-metallocene precatalyst), the metallocene precatalyst, the metallocene catalyst (made from the metallocene precatalyst), the productivity enhanced bimodal catalyst, and/or the multimodal catalyst system may be premade in the absence of the support material and later disposed onto the support material. Alternatively, the non-metallocene precatalyst, the non-metallocene catalyst, the metallocene precatalyst or the metallocene catalyst may be disposed onto the support material, and then the remaining of the non-metallocene catalyst and/or the metallocene catalyst of the productivity enhanced bimodal catalyst may be made in situ on the support material.

The non-metallocene precatalyst, the non-metallocene catalyst, the metallocene precatalyst, the metallocene catalyst, the productivity enhanced bimodal catalyst, and/or the multimodal catalyst system may be made by a concentrating method by evaporating a hydrocarbon solvent from a suspension or solution of the support material in a solution of the non-metallocene precatalyst, the non-metallocene catalyst, the metallocene precatalyst, the metallocene catalyst, the productivity enhanced bimodal catalyst, and/or the multimodal catalyst system in the hydrocarbon solvent. Alternatively, the non-metallocene precatalyst, the non-metallocene catalyst, the metallocene precatalyst, the metallocene catalyst, the productivity enhanced bimodal catalyst, and/or the multimodal catalyst system may be made by a spray-drying method by spray-drying the suspension or solution. In some embodiments the spray-drying method is used. For example, the method can comprise combining the non-metallocene precatalyst, the metallocene precatalyst, the effective amount of the activator, the effective amount of the activity-enhancing compound, the support material, and an inert hydrocarbon solvent to make a mixture, and removing the inert hydrocarbon solvent from the mixture so as to give the productivity enhanced bimodal catalyst disposed on the support material.

The support material. The support material is a particulate solid that may be nonporous, semi-porous, or porous. A carrier material is a porous support material. Examples of support materials are talc, inorganic oxides, inorganic chloride, zeolites, clays, resins, and mixtures of any two or more thereof. Examples of suitable resins are polystyrene, functionalized or crosslinked organic supports, such as polystyrene divinyl benzene polyolefins. The support material independently may be an untreated silica, alternatively a calcined untreated silica, alternatively a hydrophobing agent-treated silica, alternatively a calcined and hydrophobing agent-treated silica. The hydrophobing agent may be dichlorodimethylsilane.

Inorganic oxide support materials include Group 2, 3, 4, 5, 13 or 14 metal oxides. The preferred supports include silica, which may or may not be dehydrated, fumed silica, alumina (see, for example, PCT Publication WO 99/60033), silica-alumina and mixtures thereof. Other useful supports include magnesia, titania, zirconia, magnesium chloride (U.S. Pat. No. 5,965,477), montmorillonite (EP 0 511 665), phyllosilicate, zeolites, talc, clays (U.S. Pat. No. 6,034,187), and the like. Also, combinations of these support materials may be used, for example, silica-chromium, silica-alumina, silica-titania and the like. Additional support materials may include those porous acrylic polymers described in EP 0 767 184, which is incorporated herein by reference. Other support materials include nanocomposites as disclosed in PCT Publication WO 99/47598; aerogels as disclosed in PCT Publication WO 99/48605; spherulites as disclosed in U.S. Pat. No. 5,972,510; and polymeric beads as disclosed in PCT Publication WO 99/50311.

The support material may have a surface area in the range of from about 10 m²/g to about 700 m²/g, a pore volume in the range of from about 0.1 cm³/g to about 4.0 cm³/g, and average particle size in the range of from about 5 microns to about 500 microns. The support material may be a silica (e.g., fumed silica), alumina, a clay, or talc. The fumed silica may be hydrophilic (untreated), alternatively hydrophobic (treated). In some aspects the support is a hydrophobic fumed silica, which may be prepared by treating an untreated fumed silica with a hydrophobing agent such as dimethyldichlorosilane, a polydimethylsiloxane fluid, or hexamethyldisilazane. In some aspects the treating agent is dimethyldichlorosilane. In one embodiment, the support is Cabosil® TS-610.

One or more precatalysts and/or one or more activators may be deposited on, contacted with, vaporized with, bonded to, or incorporated within, adsorbed or absorbed in, or on, one or more support or carrier materials.

The non-metallocene precatalyst and/or the metallocene precatalyst may be spray dried according to the general methods described in U.S. Pat. No. 5,648,310. The support used with the productivity enhanced bimodal catalyst may be functionalized, as generally described in EP 0 802 203, or at least one substituent or leaving group is selected as described in U.S. Pat. No. 5,688,880.

Solution phase polymerization and/or slurry phase polymerization of olefin monomer(s) are well-known. See for example U.S. Pat. No. 8,291,115B2.

Inert hydrocarbon solvent. An alkane, an arene, or an alkylarene (i.e., arylalkane). Examples of inert hydrocarbon solvents are alkanes such as mineral oil, pentanes, hexanes, heptanes, octanes, nonanes, decanes, undecanes, dodecanes, etc., and toluene, and xylenes. In one embodiment, the inert hydrocarbon solvent is an alkane, or a mixture of alkanes, where each alkane independently has from 5 to 20 carbon atoms, alternatively from 5 to 12 carbon atoms, alternatively from 5 to 10 carbon atoms. Each alkane independently may be acyclic or cyclic. Each acyclic alkane independently may be straight chain or branched chain. The acyclic alkane may be pentane, 1-methylbutane (isopentane), hexane, 1-methylpentane (isohexane), heptane, 1-methylhexane (isoheptane), octane, nonane, decane, or a mixture of any two or more thereof. The cyclic alkane may be cyclopentane, cyclohexane, cycloheptane, cyclooctane, cyclononane, cyclodecane, methycyclopentane, methylcyclohexane, dimethylcyclopentane, or a mixture of any two or more thereof. Additional examples of suitable alkanes include Isopar-C, Isopar-E, and mineral oil such as white mineral oil. In some aspects the inert hydrocarbon solvent is free of mineral oil. The inert hydrocarbon solvent may consist of one or more (C₅-C₁₂)alkanes.

Gas-phase polymerization (GPP). The polymerization uses a GPP reactor, such as a stirred-bed gas phase polymerization reactor (SB-GPP reactor) or a fluidized-bed gas-phase polymerization reactor (FB-GPP reactor). Such reactors and methods are generally well-known. For example, the FB-GPP reactor/method may be as described in any one of U.S. Pat. Nos. 3,709,853; 4,003,712; 4,011,382; 4,302,566; 4,543,399; 4,882,400; 5,352,749; 5,541,270; US 2018/0079836 A1; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421

Gas phase polymerization operating conditions are any variable or combination of variables that may affect a polymerization reaction in the GPP reactor or a composition or property of a polyolefin polymer composition product made thereby. The variables may include reactor design and size; precatalyst composition and amount; reactant composition and amount; molar ratio of two different reactants; presence or absence of feed gases such as H₂, molar ratio of feed gases versus reactants, absence or concentration of interfering materials (e.g., H₂O and/or O₂), absence or presence of an induced condensing agent (ICA), average polymer residence time in the reactor, partial pressures of constituents, feed rates of monomers, reactor bed temperature (e.g., fluidized bed temperature), nature or sequence of process steps, time periods for transitioning between steps. Variables other than that/those being described or changed by the method or use may be kept constant.

In a GPP method, control individual flow rates of ethylene (“C₂”), hydrogen (“H₂”) and 1-hexene (“C₆” or “Cₓ” where x is 6) or 1-butene (“4” or “Cₓ” where x is 4) to maintain a fixed comonomer to ethylene monomer gas molar ratio or feed mass ratio (Cₓ/C₂, e.g., C₆/C₂) equal to a described value (e.g., 0.004 or 0.0016), a constant hydrogen to ethylene gas molar ratio or feed mass ratio (“H₂/C₂”) equal to a described value (e.g., 0.002 or 0.004), and a constant ethylene (“C₂”) partial pressure equal to a described value (e.g., 1,034 kPa or 1586 kPa). Measure concentrations of gases by an in-line gas chromatograph to understand and maintain composition in the recycle gas stream. Maintain a reacting bed of growing polymer particles in a fluidized state by continuously flowing a make-up feed and recycle gas through the reaction zone. Use a superficial gas velocity of 0.49 to 0.79 meter per second (m/sec) (1.6 to 2.6 feet per second (ft/sec)). Operate the FB-GPP reactor at a total pressure of about 2068 to about 2758 kilopascals (kPa) (about 300 to about 400 pounds per square inch-gauge (psig)) and at a described first reactor bed temperature RBT. Maintain the fluidized bed at a constant height by withdrawing a portion of the bed at a rate equal to the rate of production of particulate form of the polyolefin polymer composition, which production rate may be from 5,000 to 150,000 kilograms per hour (kg/hour). Remove the product polyolefin polymer composition semi-continuously via a series of valves into a fixed volume chamber, where this removed multimodal (e.g., bimodal or trimodal) ethylene-co-1-hexene copolymer composition is purged to remove entrained hydrocarbons and treated with a stream of humidified nitrogen (N₂) gas to deactivate any trace quantities of residual catalyst.

The bimodal catalyst system may be fed into the polymerization reactor(s) in “dry mode” or “wet mode”, alternatively dry mode, alternatively wet mode. The dry mode is a dry powder or granules. The wet mode is a suspension in an inert liquid such as mineral oil.

Induced condensing agent (ICA). An inert liquid useful for cooling materials in GPP reactor(s). Its use is optional. The ICA may be a (C₃-C₂₀)alkane, alternatively a (C₅-C₂₀)alkane, e.g., 2-methylbutane (i.e., isopentane). See U.S. Pat. Nos. 4,453,399; 4,588,790; 4,994,534; 5,352,749; 5,462,999; and 6,489,408. ICA concentration in reactor may be from 0.1 to 25 mol %, alternatively from 1 to 16 mol %, alternatively from 1 to 10 mol %.

The GPP conditions may further include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. GPP may be operated free of (not deliberately added) scavenging agents. The GPP reactor/method may further include an amount (e.g., 0.5 to 200 ppm based on all feeds into reactor) of one or more static control agents and/or one or more continuity additives such as aluminum stearate or polyethyleneimine. The static control agent(s) may be added to the FB-GPP reactor to inhibit formation or buildup of static charge therein.

The GPP reactor may be a commercial scale FB-GPP reactor such as a UNIPOL™ reactor or UNIPOL™ II reactor, which are available from Univation Technologies, LLC, a subsidiary of The Dow Chemical Company, Midland, Michigan, USA.

1-Alkene monomer. The 1-alkene monomer is a compound of formula H₂C═C(H)(CH₂)ₙR¹⁸, where subscript n is an integer from 0 to 19 and group R¹⁸ is H or CH₃. Examples are ethylene (subscript n is 0 and R¹⁸ is H), propylene (subscript n is 0 and R¹⁸ is CH₃), and a (C₄-C₂₀)alpha-olefin (subscript n is an integer from 1 to 19 and R¹⁸ is H or CH₃. In some embodiments the 1-alkene monomer is ethylene, propylene, 1-butene, 1-hexene, 1-octene, or a combination of any two or more thereof. In some embodiments the 1-alkene monomer is a combination of ethylene and propylene. In other embodiments the 1-alkene monomer is ethylene alone or a combination of ethylene and 1-butene, 1-hexene, or 1-octene.

Polyolefin polymer. A product of polymerizing at least one 1-alkene monomer with the productivity enhanced bimodal catalyst. A macromolecule, or collection of macromolecules, having constitutional units derived from the at least one 1-alkene monomer. For example, when the at least one 1-alkene monomer consists of ethylene, the polyolefin polymer consists of a polyethylene homopolymer. When the at least one 1-alkene monomer consists of ethylene and propylene, the polyolefin polymer consists of an ethylene/propylene copolymer. When the at least one 1-alkene monomer consists of ethylene and a comonomer selected from 1-butene, 1-hexene, and 1-octene, the polyolefin polymer is selected from a poly(ethylene-co-1-butene) copolymer, a poly(ethylene-co-1-hexene) copolymer, and a poly(ethylene-co-1-octene) copolymer, respectively.

The polyolefin polymer may be a homopolymer or a copolymer. The polyolefin polymer made from the productivity enhanced bimodal catalyst has a multimodal (e.g., bimodal) molecular weight distribution and comprises a higher molecular weight (HMW) polyolefin polymer component and a lower molecular weight (LMW) polyolefin polymer component. The HMW polyolefin polymer component and the LMW polyolefin polymer component may be made by the productivity enhanced bimodal catalyst.

Any compound, composition, formulation, material, mixture, or reaction product herein may be free of any one of the chemical elements selected from the group consisting of: H, Li, Be, B, C, N, O, F, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, Hf, Ta, W, Re, Os, Ir, Pt, Au, Hg, Tl, Pb, Bi, lanthanoids, and actinoids; with the proviso that chemical elements required by the compound, composition, formulation, material, mixture, or reaction product (e.g., Zr required by a zirconium compound, or C and H required by a polyethylene, or C, H, and O required by an alcohol) are not counted.

Alternatively precedes a distinct embodiment. ASTM is the standards organization, ASTM International, West Conshohocken, Pennsylvania, USA. Any comparative example is used for illustration purposes only and shall not be prior art. Free of or lacks means a complete absence of; alternatively not detectable. IUPAC is International Union of Pure and Applied Chemistry (IUPAC Secretariat, Research Triangle Park, North Carolina, USA). Periodic Table of the Elements is the IUPAC version of May 1, 2018. May confers a permitted choice, not necessarily an imperative. Operative means functionally capable or effective. Optional(ly) means is absent (or excluded), alternatively is present (or included). Properties may be measured using standard test methods and conditions. Ranges include endpoints, subranges, and whole and/or fractional values subsumed therein, except a range of integers does not include fractional values. Room temperature: 23°±1° C.

Unless stated otherwise, definitions of terms used herein are taken from the IUPAC Compendium of Chemical Technology (“Gold Book”) version 2.3.3 dated Feb. 24, 2014. Some definitions are given below for convenience.

As used herein, a “hydrocarbyl” or “hydrocarbyl group” includes aliphatic, cyclic, olefinic, acetylenic and aromatic radicals (i.e., hydrocarbon radicals) comprising hydrogen and carbon that are deficient by one hydrogen.

As used herein, an “alkyl” includes linear, branched and cyclic paraffin radicals that are deficient by one hydrogen. Thus, for example, a —CH3 group (“methyl”) and a CH3CH2- group (“ethyl”) are examples of alkyls.

As used herein, a “haloalkyl” includes any alkyl radical having one or more hydrogen atoms replaced by a halogen atom.

As used herein, “aryl” groups include phenyl, naphthyl, pyridyl and other radicals whose molecules have the ring structure characteristic of benzene, naphthylene, phenanthrene, anthracene, etc. It is understood that an “aryl’ group can be a C6 to C20 aryl group. For example, a C6H5- aromatic structure is an “phenyl”, a C6H4 2- aromatic structure is an “phenylene.”

As used herein, an “alkylene” includes linear, branched and cyclic hydrocarbon radicals deficient by two hydrogens. Thus, —CH₂— (“methylene”) and —CH₂CH₂— (“ethylene”) are examples of alkylene groups.

Reactor Additive. The systems or polymerization processes using the productivity enhanced bimodal catalyst may optionally have at least one reactor additive. The at least one reactor additive may be a flowability aid for preventing agglomeration of dry catalyst particles; an anti-static compound for inhibiting build-up of electrical charges on polyolefin particles in floating-bed gas phase polymerization reactors; or an anti-fouling compound such as a metal carboxylate salt for inhibiting reactor fouling.

Bimodal means a molecular weight distribution having two, and only two peaks as determined by GPC, where the two peaks can be a head and shoulder configuration or a two heads configuration having a local minimum (valley) therebetween. It can also refer to a catalyst that produces such a bimodal molecular weight distribution.

Catalyst herein means a material that can polymerize a monomer and optionally a comonomer so as to make a polymer. The catalyst may be an olefin polymerization catalyst, which can polymerize an olefin monomer (e.g., ethylene) and optionally an olefin comonomer (e.g., propylene and/or a (C₄-C₂₀)alpha-olefin) so as to make a polyolefin homopolymer or, optionally, a polyolefin copolymer, respectively.

Catalyst system a set of at least two chemical constituents and/or reaction products thereof that together function as an integrated whole for enhancing rate of reaction, where at least one of the at least two chemical constituents is a catalyst. The other chemical constituent(s) may be independently selected from a different catalyst, a support material, excess amount of activator, a catalyst additive such as an anti-static agent, a co-catalyst, a carboxylate metal salt, a dispersant for preventing particles of the catalyst system from sticking together. The catalyst system may comprise a catalyst and a support material, where the catalyst is disposed on the support material, which hosts and provides a physical framework for increasing surface distribution of the catalyst. Catalyst system does not include a monomer, a comonomer, or the activity-enhancing compound.

Activation. The productivity enhanced bimodal catalyst is made by way of an activation. The activation takes place between the non-metallocene precatalyst, the metallocene precatalyst, the effective amount of the activator, and the effective amount of the activity-enhancing compound, which activates the non-metallocene precatalyst and the metallocene precatalyst into the productivity enhanced bimodal catalyst. That is, the productivity enhanced bimodal catalyst is made by converting the non-metallocene precatalyst and the metallocene precatalyst into the productivity enhanced bimodal catalyst having an enhanced polymer producing functionality (e.g., having at least improved (greater) productivity). The activity-enhancing compound is free of a metal atom. Therefore, it is quite surprising that the activity-enhancing compound is capable of increasing the productivity of a catalyst made from the non-metallocene precatalyst and the metallocene precatalyst.

Consisting essentially of means free of an exogenous organometallic compound. The exogenous organometallic compound is compositionally different than the non-metallocene precatalyst and the metallocene precatalyst. Thus, the inventive method is not achieved by adding an exogenous organometallic compound or precatalyst precursor thereof. Thus, the contacting step of the method is performed in the absence of the exogenous organometallic compound or precatalyst precursor thereof. The precatalysts are not self-modifying such that they cannot increase productivity of itself or another compound. Stated differently, in the absence of the activity-enhancing compound, there is no productivity increase.

Exogenous. Having an external cause or origin or obtaining from an external source.

Feeding. Conveying or physically moving a material from outside of a space (e.g., outside a polymerization reactor) to the inside of the space (inside a polymerization reactor).

GPC means gel permeation chromatography.

Leaving group. A group bonded to the metal atom of a non-metallocene precatalyst and abstracted by an activator during the activation of the precatalyst to the non-metallocene catalyst.

Examples of leaving groups are the monodentate group X in structural Formula (C). Each non-metallocene precatalyst described herein implicitly has at least one leaving group, and typically two leaving groups.

Ligand. A monovalent, divalent, trivalent, or tetravalent and dicoordinate, tricoordinate or tetracoordinate organic group having two, three, or four, respectively coordinating functional groups for bonding to the metal atom of a non-metallocene precatalyst or a metallocene precatalyst. The ligand remains coordinated to the metal atom in either the non-metallocene catalyst or the metallocene catalyst by activating the respective precatalyst. Thus, ligand indicates a group in a non-metallocene precatalyst and/or a metallocene precatalyst that is carried over to the respective catalyst made by activating the precatalyst, whereas a leaving group indicates a labile group at least one of which is abstracted by the activator during the activating of the precatalyst.

Metal atom means a basic unit of any one of the following elements: of Groups 1 to 13, of rows 3 to 6 of Groups 14 to 16, of rows 5 and 6 of Group 17, of the lanthanides, and of the actinides, all of the Periodic Table of the Elements published by IUPAC on Dec. 1, 2018.

“Productivity-increasing” or increase productivity means transforming a productivity of an olefin polymerization catalyst by increasing the productivity thereof as compared to a productivity of the olefin polymerization catalyst under the same polymerization conditions prior to chemically converting the olefin polymerization catalyst.

Multimodal means a molecular weight distribution having two or more peaks as determined by GPC, where the two or more peaks independently can be a head and shoulder configuration or a two or more heads configuration having a local minimum (valley) therebetween. Examples of multimodal are bimodal and trimodal. It can also refer to a catalyst that produces such a multimodal molecular weight distribution.

Organic compound means a chemical entity consisting of, per molecule, carbon atoms, hydrogen atoms, optionally zero, one or more halogen atoms, and optionally zero, one, or more heteroatoms independently selected from O, N, P, and Si. The molecule does not have, i.e. is free of, a metal atom (i.e., the chemical entity does not include organometallic compounds).

Reaction conditions, including polymerization conditions, are environmental circumstances such as temperature, pressure, solvent, reactant concentrations, and the like under which a chemical transformation (e.g., polymerization) proceeds. All chemical transformations described herein are conducted under suitable and effective reaction conditions.

Support material means a finely-divided, particulate inorganic solid capable of hosting a catalyst.

Trimodal means a molecular weight distribution having three, and only three peaks as determined by GPC. It can also refer to a catalyst that produces such a trimodal molecular weight distribution.

Unsupported means free of an inorganic support material (e.g., silica).

### EXAMPLES

Some embodiments of the present disclosure will now be described in detail in the following examples. Unless indicated otherwise, all materials used herein were acquired from Sigma Aldrich.

TABLE 1
Materials

| Compound | Name | CAS | Structure |
|---|---|---|---|
| Catalyst Compound (I) | [N¹-(2,3,4,5,6-Pentamethylphenyl)- N²-[2-[(2,3,4,5,6- pentamethylphenyl)amino- _{K}N]ethyl]-1,2-ethanediaminato(2-)- _{K}N1, _{K}N²]bis(phenylmethyl)zirconium | 862377-57-9 | 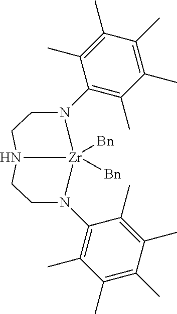 |
| Activity- enhancing compound (II-a) | 3,5-difluoro-1-ethynylbenzene | | 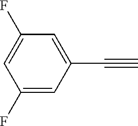 |
| Catalyst Compound (III) | Bis(1,3-dimethyl-3,4,5,6- tetrahydropentalenyl)zirconium dichloride | | 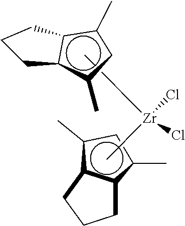 |
| Catalyst Compound (IV) | Bis(1,3-dimethyl-3,4,5,6- tetrahydropentalenyl)zirconium dimethyl | | 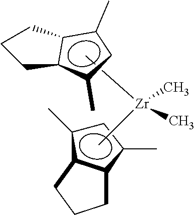 |
| | Toluene (anhydrous) | | Sigma-Aldrich |
| Activator | Methyl Aluminoxane (MAO) | | 10 wt % in toluene from |
| | | | Grace |
| Support | Fumed Silica | | CAB-O-SIL ® TS-610 |
| | | | Fumed Silica |

In the Examples, the following test procedures were used. Density was measured according to ASTM-D-1505. Melt index, MI(I₅), and flow index, FI(I₂₁), were measured according to ASTM-1238, Condition B, at 190° C. Weight average molecular weight (Mw), number average molecular weight (Mn), Mp and Mw/Mn were measured as described below. Particle size was measured using a Malvern Mastersizer laser diffraction particle size analyzer (Malvern Panalytical).

### Differential Scanning Calorimetry

Melt temperature was determined via Differential Scanning Calorimetry (DSC) according to ASTM D 3418-08. In general, a scan rate of 10° C./min on a sample of 10 mg was used, and the second heating cycle was used to determine Tₘ.

### Gel-Permeation Chromatography (GPC)

M_{w}, Mₙ, M_{z}, Mₚ and M_{w}/Mₙ (PDI) were determined using a High Temperature GPC (Polymer Laboratories), equipped with a differential refractive index detector (DRI). Three Polymer Laboratories PLgel 10 μm Mixed-B columns were used. The nominal flow rate was 1.0 mL/min, and the nominal injection volume was 300 μL. The various transfer lines, columns, and differential refractometer (the DRI detector) were contained in an oven maintained at 160° C. The solvent for the experiments was prepared by dissolving 6 grams of butylated hydroxytoluene as an antioxidant in 4 liters of Aldrich reagent grade 1, 2, 4 trichlorobenzene (TCB). The TCB mixture was then filtered through a 0.1 m Teflon filter. The TCB was then degassed with an online degasser before entering the GPC instrument. The polymer solutions were prepared by placing dry polymer in glass vials, adding the desired amount of TCB, then heating the mixture at 160° C. with continuous shaking for about 2 hours. All quantities were measured gravimetrically. The injection concentration was from 0.5 to 2.0 mg/ml, with lower concentrations being used for higher molecular weight samples. Prior to running each sample the DRI detector was purged. The flow rate in the apparatus was then increased to 1.0 ml/minute, and the DRI was allowed to stabilize for 8 hours before injecting the first sample. The molecular weight was determined by combining universal calibration relationship with the column calibration which is performed with a series of monodispersed polystyrene (PS) standards. The MW was calculated at each elution volume with following equation:

$$log {M}_{X} = \frac{log ( {K}_{X} / {K}_{P S} )}{{a}_{X} + 1} + \frac{{a}_{P S} + 1}{{a}_{X} + 1} log {M}_{P S}$$

where the variables with subscript “X” stand for the test sample while those with subscript “PS” stand for PS. In this method, a_{PS}=0.67 and K_{PS}=0.00017; while aₓ and Kₓ were obtained from published literature. Specifically, a/K=0.695/0.000579 for polyethylene and 0.705/0.0002288 for polypropylene. The concentration, c, at each point in the chromatogram was calculated from the baseline-subtracted DRI signal, IDRI, using the following equation:

$$c = KDRIIDRI / ( dn / dc )$$

where KDRI is a constant determined by calibrating the DRI, and (dn/dc) is the refractive index increment for the system. Specifically, dn/dc=0.109 for polyethylene.

The mass recovery was calculated from the ratio of the integrated area of the concentration chromatography over elution volume and the injection mass which is equal to the pre-determined concentration multiplied by injection loop volume.

All molecular weights are reported in g/mol unless otherwise noted.

The comonomer content (i.e., 1-hexene) incorporated in the polymers (weight % C6)) was determined by rapid FT-IR spectroscopy on the dissolved polymer in a GPC measurement. Comonomer content can be determined with respect to polymer molecular weight by use of an infrared detector such as an IR5 detector in a gel permeation chromatography measurement, as described in Analytical Chemistry 2014, 86(17), 8649-8656. “Toward Absolute Chemical Composition Distribution Measurement of Polyolefins by High-Temperature Liquid Chromatography Hyphenated with Infrared Absorbance and Light Scattering Detectors” by Dean Lee, Colin Li Pi Shan, David M. Meunier, John W. Lyons, Rongjuan Cong, and A. Willem deGroot. Analytical Chemistry 2014 86 (17), 8649-8656.

### Pilot Plant

### General Procedure for Catalyst Preparation

An oil-jacketed, 10 gallon, continuously stirred tank reactor (CSTR), was used for the preparation of all catalyst slurries, which were mixed at 40° C. under 6 pounds per square inch gauge (psig) (0.414 Bar) of nitrogen. The contents of the stirred tank reactor were continuously agitated at 400 rotations per minute (rpm) throughout the preparation of each catalyst slurry batch. For each batch the order of addition of components was toluene, MAO (10 wt. % in toluene), and then the silica (CAB-O-SIL® TS-610 fumed silica), followed by Catalyst Compound (I). For the inventive catalysts, Activity-enhancing compound (II-a) was added and the slurry was mixed for one hour prior to the addition of the next component (e.g., Catalyst Compound (III) or (IV)), after which the slurry was mixed for an additional hour. Compound (II-a) was not added in the preparation of the comparative catalysts. Following the addition of each catalyst compound the addition vessel was flushed with toluene (1-2 lb) and this was then added to the stirred tank reactor.

Each catalyst slurry batch was then spray dried by transferring the batch to a rotary atomizer four-whole wheel assembly. Fresh toluene was purged trough the atomizer holes until the specified exit temperature was reached and the atomized was spun at the speed specified in Table 2. Droplets of the catalyst slurry were rapidly dried upon exiting the atomizer holes by contacting with cycle gas (nitrogen) at 130° C. and the outlet temperature was 84° C. The cycle gas was used to transfer the solids into a separating cyclone which enabled collection of the solid spray dried catalysts.

### Semi-Batch Reactor Testing

### Preparation of Comparative Catalyst A (CC-A).

CC-A was prepared and sprayed in a nitrogen-purged glove box. In an oven-dried glass bottle, 1.37 g of fumed silica (CAB-O-SIL® TS-610 Fumed Silica) was slurried in 34 g of toluene until well dispersed, then 9.2 g of a 10% solution by weight of MAO in toluene and Catalyst Compound (I) (0.056 g) were added. Then Catalyst Compound (IV) (0.011 g) was added, after which the mixture was allowed to stir for a further 30-60 minutes. The mixture was spray-dried using a Buchi Mini Spray Dryer B-290 with the following parameters to yield the dried sample: Set Temperature of 140° C., an outlet temperature of 75° C. (min.), aspirator setting of 70, and a pump speed of 130 rpm.

### Preparation of Inventive Catalyst 1 (IC-1).

IC-1 was prepared and sprayed in a nitrogen-purged glove box. In an oven-dried glass bottle, 1.37 g of fumed silica (CAB-O-SIL® TS-610 Fumed Silica) was slurried in 34 g of toluene until well dispersed, then 9.2 g of a 10% solution by weight of MAO in toluene and Catalyst Compound (I) (0.056 g) were added. The mixture was stirred magnetically 15 minutes, and then compound (II-a) (3,5-difluoro-1-ethynylbenzene) (0.012 g) was added and the mixture was stirred for an additional 30 minutes before the Catalyst Compound (IV) (0.011 g) was added, after which the mixture was allowed to stir for a further 30-60 minutes. The mixture was spray-dried using a Buchi Mini Spray Dryer B-290 with the following parameters to yield the dried sample: Set Temperature of 140° C., an outlet temperature of 75° C. (min.), aspirator setting of 70, and a pump speed of 130 rpm.

### Preparation of Comparative Catalyst B (CC-B)

CC-B was prepared and sprayed in a nitrogen-purged glove box. In an oven-dried glass bottle, 0.95 g of fumed silica (CAB-O-SIL® TS-610 Fumed Silica) was slurried in 23 g of toluene until well dispersed, 6.4 g of a 10% solution by weight of MAO in toluene and Catalyst Compound (IV) (0.030 g) were added. The mixture was allowed to stir for 30-60 minutes. The mixture was spray-dried using a Buchi Mini Spray Dryer B-290 with the following parameters to yield the dried sample: Set Temperature of 140° C., an outlet temperature of 75° C. (min.), aspirator setting of 70, and a pump speed of 130 rpm.

### Preparation of Comparative Catalyst C (CC-C)

CC-C was prepared and sprayed in a nitrogen-purged glove box. In an oven-dried glass bottle, 0.95 g of fumed silica (CAB-O-SIL® TS-610 Fumed Silica) was slurried in 23 g of toluene until well dispersed, then 6.4 g of a 10% solution by weight of MAO in toluene and Catalyst Compound (IV) (0.030 g) were added. Compound (II-a) (3,5-difluoro-1-ethynylbenzene) (0.011 g) was added and the mixture was stirred for 30-60 minutes. The mixture was spray-dried using a Buchi Mini Spray Dryer B-290 with the following parameters to yield the dried sample: Set Temperature of 140° C., an outlet temperature of 75° C. (min.), aspirator setting of 70, and a pump speed of 130 rpm.

### Gas-Phase Batch Reactor Catalyst Testing Procedure:

The spray dried catalysts prepared above were used for ethylene/1-hexene copolymerizations conducted in the gas-phase in a 2 L semi-batch autoclave polymerization reactor. The individual run conditions and the properties of the polymers produced in these runs are seen in Tables 2A/2B.

The gas phase reactor employed was a 2-liter, stainless steel autoclave equipped with a mechanical agitator. For the experimental runs, the reactor was first dried for 1 hour, charged with 200 g of NaCl and dried by heating at 100° C. under nitrogen for 30 minutes. After baking out the reactor, 5 g of SMAO (silica supported methylaluminoxane) was introduced as a scavenger under nitrogen pressure. After adding SMAO, the reactor was sealed and components were stirred. The reactor was then charged with hydrogen (2.50 L) and 1-hexene (C6/C2=0.004), then pressurized with ethylene (C2PP=230 psi). Once the system reached a steady state, the catalyst was charged into the reactor at either 80° C. or 100° C. to start polymerization. The run was started at either 100° C. or at 80° C. and then the reactor temperature was brought to 100° C. and maintained at this temperature, and hydrogen (H2/C2=0.004) and comonomer (C6/C2=0.004) feeds, throughout the 3 hour run. At the end of the run, the reactor was cooled down, vented and opened. The resulting product mixture was washed with water and methanol, then dried. Polymerization Activity (grams polymer/gram catalyst-hour) was determined as the ratio of polymer produced to the amount of catalyst added to the reactor.

TABLE 2A
Semi-Batch Reactor Testing Results

| | | | Catalyst | | | Melting | Heat of |
|---|---|---|---|---|---|---|---|
| | | | Charge | Yield | Productivity | Temp | Melting |
| | Catalyst | Condition | (mg) | (g) | (gPE/gCat) | (° C.) | (J/g) |
| CE-A | CC-A | A | 6.1 | 42.16 | 6,912 | 132.1 | 159 |
| IE-1 | IC-1 | A | 6.0 | 52.40 | 8,661 | 131.3 | 140 |
| CE-B | CC-B | A | 6.1 | 38.99 | 6,390 | 132.4 | 202 |
| CE-C | CC-C | A | 6.6 | 31.54 | 4,815 | 132.5 | 181 |
| CE-D | CC-A | B | 6.3 | 58.99 | 9,363 | 131.5 | 167 |
| IE-2 | IC-1 | B | 6.0 | 63.99 | 10,665 | 130.9 | 149 |
| CE-E | CC-B | B | 6.4 | 47.18 | 7,371 | 132.7 | 209 |
| CE-F | CC-C | B | 6.4 | 34.19 | 5,385 | 132.3 | 198 |

Condition A: run temperature = 100° C., injection temperature = 100° C., C6/C2 = 0.004, H2/C2 = 0.004, C2PP = 230 psi, 2.5 L H2 preload, run time 3 hours. Condition B: run temperature = 100° C., injection temperature = 80° C., C6/C2 = 0.004, H2/C2 = 0.004, C2PP = 230 psi, 2.5 L H2 preload, run time 3 hours.

TABLE 2B
Semi-Batch Reactor Testing Results

| | Max. | Time to | | | Flow | |
|---|---|---|---|---|---|---|
| | T_{int.} | Tmax | | Melt | Index, | MFR |
| | (° C.) | (sec) | wt % C6 | Flow, I5 | I21 | (I21/I5) |
| CE-A | 117.3 | 63.5 | 1.013 | No Flow | 1.29 | n/a |
| IE-1 | 105.2 | 72.0 | 1.272 | No Flow | 0.41 | n/a |
| CE-B | 108.0 | 68.0 | 0.618 | 300.835 | 182.25 | 0.61 |
| CE-C | 106.0 | 64.0 | 0.876 | 363.192 | 258.77 | 0.71 |
| CE-D | 99.8 | n/a | 0.771 | No Flow | 0.98 | n/a |
| IE-2 | 99.8 | n/a | 0.858 | No Flow | 0.48 | n/a |
| CE-E | 99.9 | n/a | 0.728 | 352.084 | 233.68 | 0.66 |
| CE-F | 99.8 | n/a | 0.802 | 188.057 | 322.71 | 1.72 |

Condition A: run temperature = 100° C., injection temperature = 100° C., C6/C2 = 0.004, H2/C2 = 0.004, C2PP = 230 psi, 2.5 L H2 preload, run time 3 hours. Condition B: run temperature = 100° C., injection temperature = 80° C., C6/C2 = 0.004, H2/C2 = 0.004, C2PP = 230 psi, 2.5 L H2 preload, run time 3 hours. Wt % 1-hexene was calculated from amount of ethylene and 1-hexene consumed during the run. Temperature data was collected every 15 seconds during the run. Under condition B none of the run temperatures exceeded the target run temperature.

TABLE 2C
Semi-Batch Reactor Testing Polymer Data

| | Mn | Mw | Mz | Mp | Mw/Mn | Mz/Mw | Wt % C6 |
|---|---|---|---|---|---|---|---|
| CE-A | 18,247 | 396,733 | 2,105,596 | 272,341 | 21.74 | 5.31 | 1.36 |
| IE-1 | 29,005 | 420,919 | 1,832,766 | 249,473 | 14.51 | 4.35 | 0.94 |
| CE-B | 7,449 | 20,485 | 38,665 | 17,378 | 2.75 | 1.89 | 0.85 |
| CE-C | 6,948 | 20,145 | 39,260 | 16,218 | 2.90 | 1.95 | 0.49 |
| CE-D | 17,405 | 349,341 | 1,804,755 | 269,991 | 20.07 | 5.17 | 1.13 |
| IE-2 | 33,317 | 532,431 | 2,182,426 | 280,276 | 15.98 | 4.10 | 1.16 |
| CE-E | 7,427 | 20,193 | 37,576 | 17,378 | 2.72 | 1.86 | 0.32 |
| CE-F | 6,944 | 19,595 | 37,814 | 16,218 | 2.82 | 1.93 | 0.82 |

Condition A: run temperature = 100° C., injection temperature = 100° C., C6/C2 = 0.004, H2/C2 = 0.004, C2PP = 230 psi, 2.5 L H2 preload, run time 3 hours. Condition B: run temperature = 100° C., injection temperature = 80° C., C6/C2 = 0.004, H2/C2 = 0.004, C2PP = 230 psi, 2.5 L H2 preload, run time 3 hours. Wt % 1-hexene was calculated from GPC/IR.

### Productivity Increase and Indirect Metallocene Impact of Activity-Enhancing Compound

Table 2A shows in increase in productivity for IC-1 compared to CC-A. Under A conditions IC-1 (IE-!) has 25% increase in productivity compared to CC-A (CE-A) and under condition B IC-1 (IE-2) has a 14% increase in productivity compared to CC-A (CE-D). In contrast, when the activity enhancing compound is combined the metallocene component only (CC-C) there is a drop in productivity compared to the metallocene without activity enhancing compound present (CC-B). Under condition A there is a 25% drop in productivity (CE-B and CE-C) and under condition B a 27% drop in productivity for CC_C compared to CC-B (CE-E and CE-F). This shows no direct impact on the metallocene component.

### Light-Off/Temperature

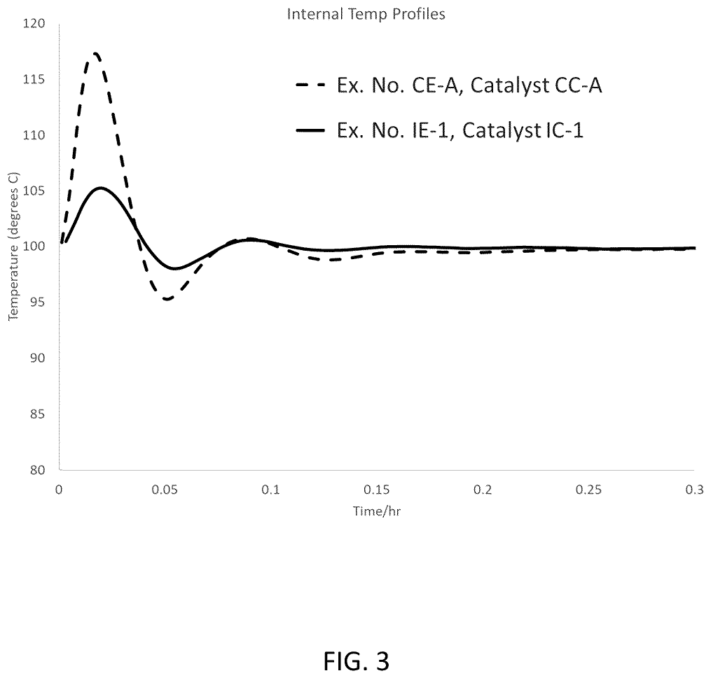

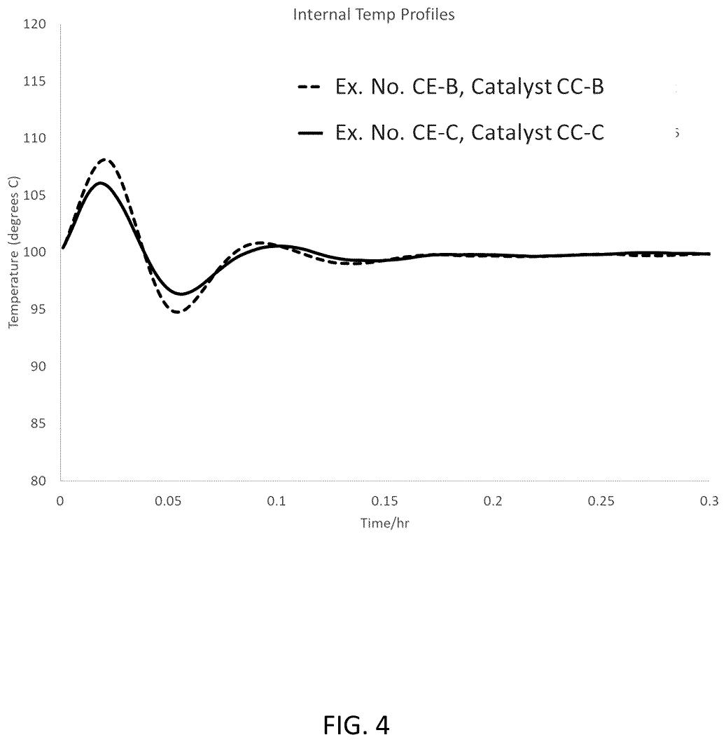

A decrease in the catalyst light-off is seen by using condition A for IC-1 compared to CC-A where the maximum reactor temperature drops to 105.2° C. for the inventive catalyst (IE-1) compared to 117.3° C. for the comparative catalyst example (CE-A), a drop of 12.1° C. The time to maximum temperature is also longer for the inventive catalyst. FIG. 3 shows the light-off differences of the inventive catalysts described above. This is a surprising result as higher temperature is typically the result of lower productivity, but the inventive catalyst has both higher productivity and an attenuated light-off. For the metallocene component only there is only a 2° C. difference in temperature which is consistent with the 25% drop in productivity and the maximum reactor temperature occurs at the same time (CE-B and CE-C). FIG. 4 shows the light-off similarities of the metallocene catalysts described above.

TABLE 3A
Semi-Batch Reactor Test Ethylene Flow and Uptake
Data for bimodal catalysts at condition A.

| | Ex. No. | | | |
|---|---|---|---|---|
| | CE-A | IE-1 | CE-B | CE-C |
| | Catalyst | | | |
| | CC-A | IC-1 | CC-B | CC-C |
| Max instantaneous C2 uptake (slpm) | 8.714 | 2.789 | 3.720 | 3.590 |
| C2 uptake at t = 0.1 h (slpm) | 1.281 | 1.193 | 1.207 | 1.049 |
| C2 uptake at t = 0.3 h (slpm) | 0.558 | 0.870 | 0.587 | 0.374 |
| C2 uptake at t = 0.9 h (slpm) | 0.221 | 0.332 | 0.170 | 0.137 |
| ζ(0.1): | 0.147 | 0.428 | 0.324 | 0.292 |
| ζ(0.3): | 0.064 | 0.312 | 0.158 | 0.104 |
| ζ(0.9): | 0.025 | 0.119 | 0.046 | 0.038 |
| AEI(0.1) | 1.000 | 2.908 | 1.000 | 0.901 |
| AEI(0.3) | 1.000 | 4.869 | 1.000 | 0.660 |
| AEI(0.9) | 1.000 | 4.687 | 1.000 | 0.837 |

Conditions: run temperature = 100° C., injection temperature = 100° C., C6/C2 = 0.004, H2/C2 = 0.004, C2PP = 230 psi, run time 3 hours.

TABLE 3B
Semi-Batch Reactor Test Ethylene Flow and Uptake
Data for bimodal catalysts at condition B.

| | Ex. No. | | | |
|---|---|---|---|---|
| | CE-D | IE-B | CE-E | CE-F |
| | Catalyst | | | |
| | CC-A | IC-1 | CC-B | CC-C |
| Max instantaneous C2 uptake (slpm) | 5.079 | 1.576 | 2.288 | 1.902 |
| C2 uptake at t = 0.1 h (slpm) | 2.246 | 1.314 | 1.423 | 1.067 |
| C2 uptake at t = 0.3 h (slpm) | 0.719 | 1.055 | 0.836 | 0.599 |
| C2 uptake at t = 0.9 h (slpm) | 0.231 | 0.368 | 0.216 | 0.174 |
| ζ(0.1): | 0.442 | 0.834 | 0.622 | 0.561 |
| ζ(0.3): | 0.142 | 0.669 | 0.365 | 0.315 |
| ζ(0.9): | 0.045 | 0.234 | 0.094 | 0.091 |
| AEI(0.1) | 1.000 | 1.887 | 1.000 | 0.902 |
| AEI(0.3) | 1.000 | 4.728 | 1.000 | 0.862 |
| AEI(0.9) | 1.000 | 5.143 | 1.000 | 0.969 |

Conditions: run temperature = 80° C., injection temperature = 100° C., C6/C2 = 0.004, H2/C2 = 0.004, C2PP = 230 psi, run time 3 hours.

### Catalyst Kinetics and Lifetime

The kinetics and lifetimes of the catalysts can be quantified by the ethylene (C2) uptakes of the bimodal catalysts and metallocene controls as measured during the semi-batch reactor test method are quantified in Tables 3A-3B. The maximum C2 uptake reached during the reactor for the inventive bimodal catalyst IC-1 made with the activity enhancing compound (AEC) is lower, i.e., <3.0 slpm (examples IE-1 and IE-2) while the bimodal catalyst without the AEC had much higher maximum ethylene uptake, i.e., >5.0 slpm (examples CE-A and CE-D). A higher maximum ethylene uptake is also representative of a greater light-off, which corresponds to maximum internal reactor temperatures as reported in Table 2B.

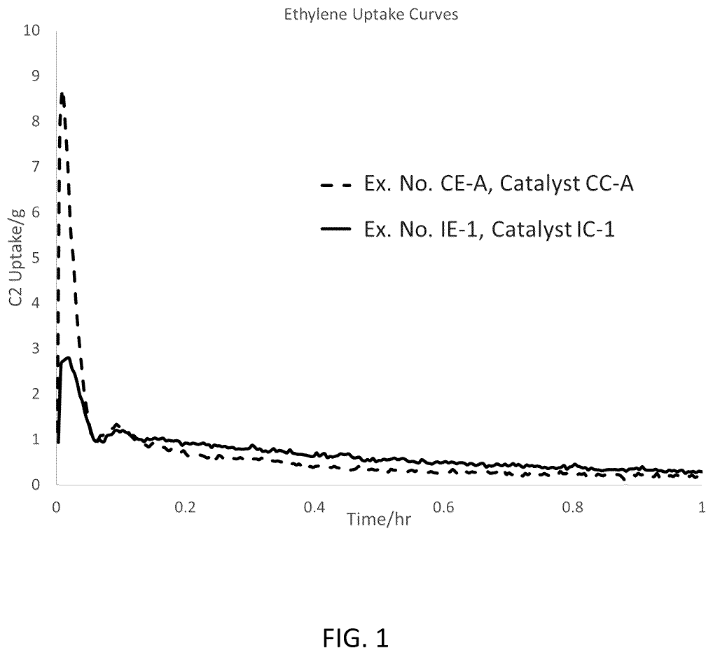

The ethylene uptake of the inventive catalyst in examples IE-1 and IE-2 have lower decays than the comparative examples CE-A and CE-D, which can be seen as larger ethylene uptakes at t=0.300 and t=0.9 hours despite having lower maximum ethylene uptakes than the comparatives. For instance, despite having significantly lower maximum C2 uptake values, the C2 uptake at t=0.3 hours of inventive examples IE-1 and IE-2 are greater, i.e., 0.870 slpm and 1.055 slpm, respectively, than the corresponding C2 uptake at t=0.3 hours of the comparative examples CE-A, i.e., 0.558 slpm, and CE-D, i.e., 0.719 slpm. FIG. 1 shows the differences in the ethylene uptakes of the inventive and comparative catalyst described above.

The ratio of ethylene uptake at each of these time points to the maximum ethylene uptake is reported in tables 3A-3C and given by the general equation (1) and specific equations (II) to (IV):

$$C 2 Uptake Ratio at time t , ζ ( t ) = \frac{C 2 Uptake at t}{Max C 2 Uptake} \qquad ( I )$$

$$C 2 Uptake Ratio at 0.1 hours , ζ ( 0.1 ) = \frac{C 2 Uptake at t = 0.1}{Max C 2 Uptake} \qquad ( II )$$

$$C 2 Uptake Ratio at 0.3 hours , ζ ( 0.3 ) = \frac{C 2 Uptake at t = 0.3}{Max C 2 Uptake} \qquad ( III )$$

$$C 2 Uptake Ratio at 0.9 hours , ζ ( 0.9 ) = \frac{C 2 Uptake at t = 0.9}{Max C 2 Uptake} \qquad ( IV )$$

The effect of the AEC additive on the kinetics of the productivity enhanced bimodal catalyst, as shown by the ethylene uptake curves, can be quantified by the additive effectiveness index, AIE, which is the ratio of ζ(t) of the productivity enhanced bimodal catalyst to the ζ(t) of the bimodal catalyst without the AEC. The AEC can be given by the general formula (V) and the specific formulae (VI) to (VIII):

$$Additive effectiveness index at time t , AIE ( t ) = \frac{Additive Catalyst ζ ( t )}{Catalyst with no additive ζ ( t )} \qquad ( V )$$

$$Additive effectiveness index at 0.1 hours , AIE ( 0.1 ) = \frac{Additive Catalyst ζ ( 0.1 )}{Catalyst with no additive ζ ( 0.1 )} \qquad ( VI )$$

$$Additive effectiveness index at 0.3 hours , AIE ( 0.3 ) = \frac{Additive Catalyst ζ ( 0.3 )}{Catalyst with no additive ζ ( 0.3 )} \qquad ( VII )$$

$$Additive effectiveness index at 0.1 hours , AIE ( 0.9 ) = \frac{Additive Catalyst ζ ( 0.9 )}{Catalyst with no additive ζ ( 0.9 )} \qquad ( VIII )$$

The additive effectiveness indices (AEI(t)) are given in Tables 3A-3C. Each AEI(t) for IE-1 were compared to the AEI(t) of CE-A. Likewise, each AEI(t) for IE-2 were compared to the AEI(t) of CE-B. The AIE(t) values close to 1 indicated no significant change in the kinetics as shown by the ethylene uptake curves. An AIE(t)>1.5 indicate a significant impact on the kinetics of the catalyst. The AEI(0.1), AEI(0.3), and AEI(0.9) are all greater, i.e., larger, than 1.8 for the inventive examples IE-1 and IE-2.

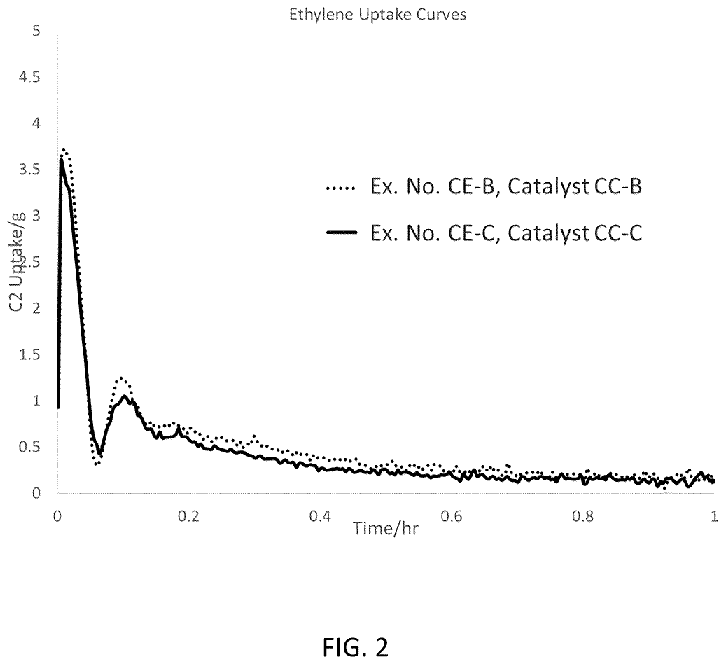

The additive effectiveness index can also be used to show that there is no direct impact of the AEC on the metallocene compound (Table 3B). The AEI(0.1), AIEI(0.3), and AEI(0.1) values are all close to 1, indicating no significant change to the kinetics of the metallocene with the addition of the AEC. FIG. 2 shows the light-off comparable ethylene uptakes of both metallocene catalysts described above. Additionally, the lower productivity (4,815 compared to 6,390 at condition A) coupled with the slightly lower maximum C2 uptake (3.590 slpm compared to 3.720 slpm at condition A) of CE-C compared to that of CE-B indicate a poisoning effect of the additive compound on the metallocene when contacted directly and not as part of the bimodal catalyst system.

The lifetime of the catalyst can be quantified from the same semi-batch reactor test as described above. Comparisons must be taken at equivalent reaction conditions (i.e., the same process conditions such as temperature, ethylene to comonomer molar ratio, ethylene to hydrogen molar ratio, ethylene partial pressure, catalyst charge amount, etc.). The productivity enhanced bimodal catalyst IC-1 (example IE-1) has a longer lifetime than the comparative catalyst CC-A (example CE-A), which is quantified by having a lower maximum instantaneous ethylene uptake (i.e, 2.789 slpm vs 8.714 splm), but having greater, i.e., larger, instantaneous uptake values at time points if the reaction. Specifically the uptake at t=0.3 hours (0.870 slpm vs 0.558 slpm), and at t=0.9 hours (0.332 slpm vs 0.221 slpm). The lifetime can also be expressed as the ratio of the uptake at a given time (t) and is denoted by the Greek letter zeta, i.e., ζ(t). Larger values for ζ(0.1), ζ(0.3), and ζ(0.9) correspond to longer catalyst lifetimes, as seen for productivity enhanced bimodal catalyst examples IE-1 and IE-2 compared to CE-A and CE-D. For the two metallocene examples in Table 3B the values of ζ(0.1), ζ(0.3), and ζ(0.9) are quite similar to each other regardless of the presence of the activity enhancing compound, again showing no direct impact on the metallocene component by the AEC.

1. A method of making a productivity enhanced bimodal catalyst, the method comprising:
combining a non-metallocene precatalyst, a metallocene precatalyst, an effective amount of an activator to activate the non-metallocene precatalyst and the metallocene precatalyst, and an effective amount of an activity-enhancing compound into the productivity enhanced bimodal catalyst; wherein the activity-enhancing compound is of Formula (A): 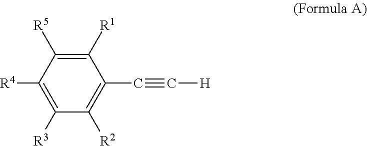
wherein each of R⁵, R⁴ and R³ independently is H, a halogen, a (C₁-C₂₀)hydrocarbyl, or a (C₁-C₂₀)heterohydrocarbyl; with the proviso that at least one of R⁵ and R³ is a halogen or a haloalkyl; wherein each of R² and R¹ independently is H, a halogen, a (C₁-C₂₀)hydrocarbyl or a (C₁-C₂₀)heterohydrocarbyl, wherein each (C₁-C₂₀)hydrocarbyl or (C₁-C₂₀)heterohydrocarbyl independently is unsubstituted or substituted with from 1 to 4 substituent groups R^{S}; wherein each substituent group R^{S} is independently selected from halogen, unsubstituted (C₁-C₅)alkyl, —C≡CH, —OH, (C₁-C₅)alkoxy, —C(═O)-(unsubstituted (C₁-C₅)alkyl), —NH₂, —N(H)(unsubstituted (C₁-C₅)alkyl), —N(unsubstituted (C₁-C₅)alkyl)₂, —COOH, —C(═O)—NH₂, —C(═O)—N(H)(unsubstituted (C₁-C₅)alkyl), —C(═O)—N(unsubstituted (C₁-C₅)alkyl)₂, —S-(unsubstituted (C₁-C₅)alkyl), —S(═O)₂-(unsubstituted (C₁-C₅)alkyl), —S(═O)₂—NH₂, —S(═O)₂—N(H)(unsubstituted (C₁-C₅)alkyl), —S(═O)₂—N(unsubstituted (C₁-C₅)alkyl)₂, —C(═)S-(unsubstituted (C₁-C₅)alkyl) and —COO(unsubstituted (C₁-C₅)alkyl); and wherein the metallocene precatalyst is of Formula (B): 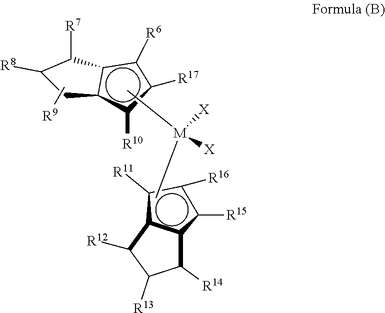
wherein M is a Group 4 element, each X is, independently, a hydride group, an amide, a benzyl group, a methyl group, a chloro group, a fluoro group, a methylene(trimethylsilyl) group, a hydrocarbyl group, or a heterohydrocarbyl group; each of R⁶, R¹⁰, R¹¹ and R¹⁵ independently is a (C₁-C₁₀)hydrocarbyl, or a (C₁-C₁₀)heterohydrocarbyl; and each of R⁷, R⁸, R⁹, R¹², R¹³, R¹⁴, R¹⁶ and R¹⁷ independently is a H, a (C₁-C₁₀)hydrocarbyl, or a (C₁-C₁₀)heterohydrocarbyl.

2. The method of claim 1 wherein each of R⁵ and R³ is independently a halogen or haloalkyl; each of R² and R¹ is H; R⁴ is selected from H, hydrocarbyl, halogen and haloalkyl.

3. The method of claim 1 wherein the activity-enhancing compound is 3,5-difluoro-1-ethynylbenzene:

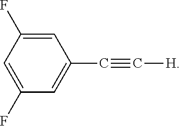

4. The method of claim 1 wherein the one of R⁵ and R³ is halogen or haloalkyl and the other is hydrogen.

5. The method of claim 1 wherein the activity-enhancing compound is 3-fluoro-1-ethynylbenzene or 3,4-difluoro-1-ethynylbenzene:

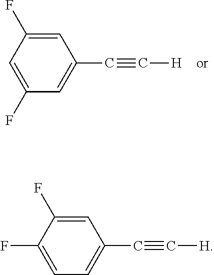

6. The method of claim 1 wherein each of R⁷, R⁸, R⁹, R¹², R¹³, R¹⁴, R¹⁶ and R¹⁷ is H; each of R⁶, R¹⁰, R¹¹ and R¹⁵ is a (C₁-C₅)hydrocarbyl; M is Zr and each X is a chloro group or a (C₁-C₃)hydrocarbyl.

7. The method of claim 6 wherein each of R⁶, R¹⁰, R¹¹, and R¹⁵ is a C₁ hydrocarbyl and each X is a chloro group or a methyl group.

8. The method of claim 1 wherein the metallocene precatalyst of Formula (B) is selected from the group consisting of Compound (1): 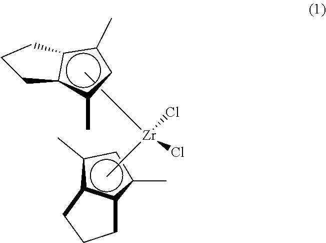
and Compound (2):

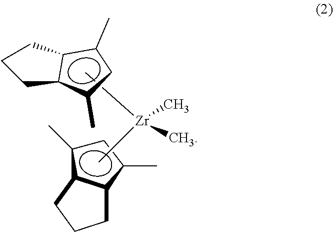

9. The method of claim 1 wherein the method further comprises combining the non-metallocene precatalyst, the metallocene precatalyst, the effective amount of the activator, the effective amount of the activity-enhancing compound, a support material, and an inert hydrocarbon solvent to make a mixture, and removing the inert hydrocarbon solvent from the mixture so as to give the productivity enhanced bimodal catalyst disposed on the support material.

10. The method of claim 1 wherein the non-metallocene precatalyst is a non-metallocene precatalyst of Formula (C) 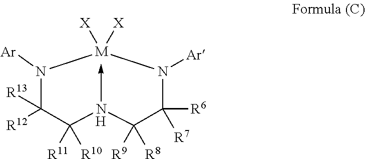
wherein M is a group 4 element, each of R⁶-R¹³ are independently a hydrogen or a methyl group, Ar is an aryl group or a substituted aryl group, Ar′ is an aryl group or a substituted aryl group, and each X is, independently, a hydride group, an amide, a benzyl group, a methyl group, a chloro group, a fluoro group, a methylene(trimethylsilyl) group, a hydrocarbyl group, or a heterohydrocarbyl group.

11. The method of claim 1 wherein the non-metallocene precatalyst of formula (I) is of compound (3): 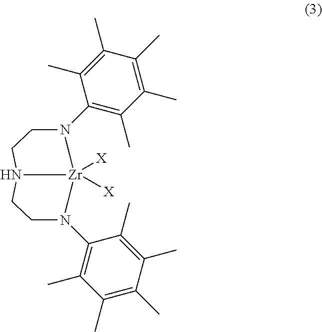
wherein each X is, independently, a hydride group, an amide, a benzyl group, a methyl group, a chloro group, a fluoro group, methylene(trimethylsilyl) group, a hydrocarbyl group, or a heterohydrocarbyl group.

12. The method of claim 11 the non-metallocene precatalyst of Formula (C) is of compound (4):

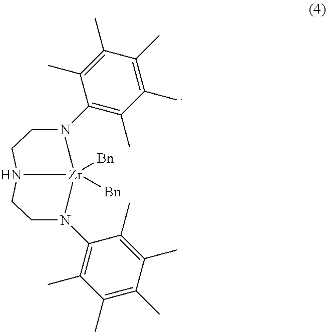

13. The method of claim 1 wherein the metal of the non-metallocene precatalyst is M, wherein the activator is an organoaluminum compound, and wherein the effective amount of the activator is an Al/M molar ratio of from 0.5 to 10,000, alternatively from 0.95 to 200, alternatively from 1.0 to 150, alternatively from 10 to 100; and/or wherein the effective amount of the activity-enhancing compound comprises a molar ratio of activity-enhancing compound-to-non-metallocene precatalyst (AEC/NMC molar ratio) of from 0.2:1.0 to 50.0:1.0, alternatively from 0.9:1.0 to 20.0:1.0, alternatively from 0.9:1.0 to 11:1.0, alternatively from 0.95:1.0 to 6:1.0, alternatively from 0.95:1.0 to 1.2:1.0.

14. The method of claim 1, including using the metallocene precatalyst of Compound (2) 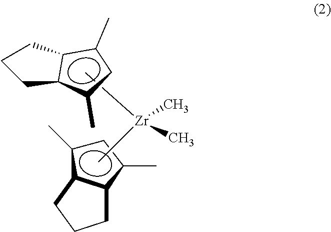
as a trim catalyst.

15. A productivity enhanced bimodal catalyst made by the method of claim 1.

16. A method of feeding a productivity enhanced bimodal catalyst to a slurry-phase, solution-phase, or gas-phase polymerization reactor containing an olefin monomer and a moving bed of polyolefin polymer, the method comprising making the productivity enhanced bimodal catalyst outside of the reactor and according to the method of claim 1, and feeding the productivity enhanced bimodal catalyst in neat form or as a solution or slurry thereof in an inert hydrocarbon liquid or mineral oil through a feed line free of olefin monomer into the slurry-phase, solution-phase, or gas-phase polymerization reactor.

17. The method of claim 16, further including using the metallocene precatalyst of Compound (2): 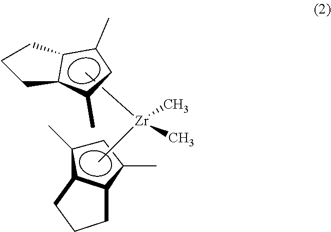
as a trim catalyst with the productivity enhanced bimodal catalyst.

18. The catalyst of the method of claim 16 such that the productivity enhanced bimodal catalyst has a decreased trim requirement compared to the bimodal without an activity enhancing compound, which can be measured in a continuous process by a decreased amount of trim in moles relative to the base catalyst, or an increased activity in lb PE/mol of the low molecular weight metallocene catalyst, which is accompanied by an increase in activity in lb PE/mol of the high molecular weight non-metallocene catalysts.

19. The method of claim 15 further including using a continuity additive with the productivity enhanced bimodal catalyst in the slurry-phase, solution-phase, or gas-phase polymerization reactor.

20. The method of claim 1 of making a productivity enhanced bimodal catalyst with an activity enhancing compound such that the kinetics are improved which can be measured by the semi-batch reactor test method by showing a decrease in the maximum reactor temperature or independently by the activity enhancing index, AEI, as given by Formula (I):
$$Additive effectiveness index at time t , AIE ( t ) = \frac{Additive Catalyst ζ ( t )}{Catalyst with no additive ζ ( t )} \qquad ( I )$$
which can be measured by the semi-batch reactor test described in the Examples and t is the time given in hours of the batch reactor test, ζ(t) is the measured ethylene uptake, or consumption of the catalyst, and the additive catalyst refers to the productivity enhanced bimodal catalyst and the catalyst with no additive refers to the bimodal catalyst without the activity enhancing compound; and the AEI(0.3) refers to the activity enhancing index at 0.3 hours and AEI(0.3)>2.0; alternatively the AEI(0.3)>4.0.
